(19) United States
(12) Patent Application Publication
(10) Pub. No.: US 2010/0182800 A1
(43) Pub. Date: Jul. 22, 2010

(54) LINEAR LIGHT-EMITTING DEVICE

(76) Inventors: Reiko Taniguchi, Osaka (JP); Masayuki Ono, Osaka (JP); Shogo Nasu, Hyogo (JP); Eiichi Satoh, Osaka (JP); Toshiyuki Aoyama, Osaka (JP); Kenji Hasegawa, Osaka (JP); Masaru Odagiri, Hyogo (JP)

Correspondence Address: MCDERMOTT WILL & EMERY LLP, 600 13TH STREET, NW, WASHINGTON, DC, 20005-3096, US

(21) Appl. No.: 12/519,303

(22) PCT Filed: Dec. 5, 2007
(86) PCT No.: PCT/JP2007/073476

§ 371 Date: Jun. 15, 2009

(30) Foreign Application Priority Data
Dec. 15, 2006 (JP) 2006-338127
Dec. 15, 2006 (JP) 2006-338130

(51) Int. Cl. H05B 33/02; F21V 7/00

(52) U.S. Cl. 362/609; 313/499; 313/501

(57) ABSTRACT

A linear light-emitting device is provided with a pair of first and second linear electrodes opposing each other, and a linear phosphor layer is sandwiched between the paired electrodes, with at least one of the paired first and second electrodes being a transparent electrode, and the phosphor layer has a polycrystalline structure made from a first semiconductor substance, with a second semiconductor substance different from the first semiconductor substance being segregated on a grain boundary of the polycrystalline structure.

### BACKGROUND OF THE INVENTION

1. Technical Field

The present invention relates to a linear light-emitting device in which an electroluminescence element is used.

2. Background Art

In recent years, among many kinds of flat-face-type display devices, high expectations have been drawn to display devices using electroluminescence elements. The display device using the El elements has such characteristics that it exerts a spontaneous light emitting property, is superior in visibility, has a wide viewing angle and is fast in response. Moreover, the currently developed EL elements include inorganic EL elements that use an inorganic material as an illuminant and organic EL elements that use an organic material as an illuminant.

In the inorganic EL element, for example, an inorganic phosphor such as zinc sulfide is used as the luminescent material, and electrons accelerated by a high electric field such as 10⁶ V/cm are allowed to collide with the luminescence center of the phosphor so as to be excited, and light is emitted as those electrons are relaxed. Moreover, the inorganic EL elements include dispersion-type EL elements in which a phosphor layer formed by dispersing powdered phosphor in a polymer organic material or the like is prepared, with electrodes being formed on the upper and lower sides thereof, and thin-film-type EL elements in which two layers of dielectric layers are formed between a pair of electrodes, and a thin-film phosphor layer, sandwiched between the two dielectric layers, is formed. Among these, the former dispersion-type EL elements have low luminance and a short service life, although they are easily manufactured, with the result that the application thereof has been limited. In contrast, in the latter thin-film-type EL elements, those elements having a double insulating structure, proposed by Inokuchi, et al. in 1974, have been proved to have high luminance and a long service life, and have been put into practical use as in-vehicle displays and the like, as described in Japanese Patent Laid-open Publication No. 52-33491.

Conventional inorganic EL elements will be described with reference to FIG. 27. FIG. 27 is a cross-sectional view perpendicular to the light emitting face of a thin-film-type EL element 50 having the double insulating structure. This EL element 50 has a structure in which on a substrate 51, a transparent electrode 52, a first dielectric layer 53, a phosphor layer 54, a second dielectric layer 55 and a back electrode 56 are laminated in this order. An AC voltage is applied between the transparent electrode 52 and the back electrode 56 from an AC voltage supply 57 so that light emission is taken out from the transparent electrode 52 side. The dielectric layers 53 and 55 have a function for regulating an electric current flowing through the phosphor layer 54 so that they can prevent dielectric breakdown of the EL element 50 and function so as to provide a stable light-emitting characteristic. Moreover, a display device of a passive matrix driving system has been known in which transparent electrodes 52 and back electrodes 56 are patterned into stripes so as to be made orthogonal to each other, and by applying a voltage to a specific selected pixel in the matrix, a desired pattern displaying operation is carried out.

Dielectric materials to be used as the dielectric layers 53 and 54 preferably have a high dielectric constant, with high insulating resistance and high withstand voltage, and in general, dielectric materials having a perovskite structure, such as Y₂O₃, Ta₂O₅, Al₂O₃, Si₃N₄, BaTiO₃, SrTiO₃, PbTiO₃, CaTiO₃ and Sr(Zr, Ti)O₃, are used. In general, inorganic phosphor materials to be used as the phosphor layer 54, on the other hand, have a structure in which an insulating substance crystal is used as a host crystal that is doped with an element serving as a luminescence center. Since those materials that are stable physically as well as chemically are used as the host crystal, the inorganic EL element is superior in reliability, and achieves a service life for 30,000 hours or more. For example, the phosphor layer is mainly composed of ZnS, and doped with a transition metal element and a rare-earth element, such as Mn, Cr, Tb, Eu, Tm and Yb, so that the light emission luminance can be improved, as described in Japanese Patent Publication No. 54-8080

In general, a compound semiconductor consisting of Group 12 and Group 16, such as ZnS, to be used as the phosphor layer 54, has a polycrystalline structure. For this reason, there are many crystal grain boundaries in the phosphor layer 54. Since these crystal grain boundaries serve as scattering bodies for electrons accelerated by an electric field application, the exciting efficiency of the luminescence center is extremely lowered. Moreover, in the crystal grain boundaries, a lattice strain becomes greater due to deviations and the like of the crystal orientation, with the result that there are many non-irradiation recombination centers that give adverse effects to the EL light emission. Because of these influences, the light emission luminance of the inorganic EL element is low, failing to be practically used.

In order to solve the above-mentioned problems, methods for enlargement of the grain size and the improvement of the crystallinity of the crystal grain diameter of the phosphor layer have been proposed. In accordance with a technique, as described in Japanese Patent Laid-open Publication No. H06-36876, an inorganic EL element is designed so that a first electrode has a specific crystal orientation, a first dielectric layer to be laminated thereon has a crystal orientation equivalent to that of the first electrode and a phosphor layer to be further laminated thereon has a crystal orientation equivalent to that of the first dielectric layer; thus, the crystal grain boundary relative to the thickness direction is suppressed so that light emission luminance is improved. Moreover, in accordance with a technique, as described in Patent Laid-open Publication No. H06-196262, in the phosphor layer to which a rare-earth element has been added, the number of crystal growing cores in the initial growing period is set to a uniform and appropriate value by specifying the concentration of the rare earth element. With this arrangement, pillar-shaped crystals having uniformed particle sizes can be formed from the initial stage of the growth so that the light emission luminance can be improved.

### SUMMARY OF THE INVENTION

In the case where the above-mentioned inorganic EL element is utilized as a backlight for use in a high quality display device such as a television, luminance as high as 300 cd/cm² is required. Although the above-mentioned proposal provides a certain degree of effects, the light emission luminance is 150 cd/cm², which is still an insufficient level. Moreover, upon light emission, it is normally necessary to apply a voltage of several 100 V. Moreover, in order to maintain the light emission, it is necessary to apply a high frequency AC voltage with several 10 kHz.

An object of the present invention is to provide a linear light-emitting device that is capable of emitting light at a low voltage, and has high luminance and high efficiency.

A linear light-emitting device according to the present invention includes: a pair of first and second linear electrodes opposing each other; and

a linear phosphor layer sandwiched between the paired electrodes,

wherein at least one of the paired first and second electrodes is a transparent electrode, and the phosphor layer has a polycrystalline structure made from a first semiconductor substance, with a second semiconductor substance different from the first semiconductor substance being segregated on a grain boundary of the polycrystalline structure.

The phosphor layer may have an electric resistance value between the first and second electrodes that is varied in a longitudinal direction.

The phosphor layer may be divided into a plurality of regions by a plurality of insulators placed between the paired electrodes.

The phosphor layer may have a film thickness that is varied in the longitudinal direction.

The linear light-emitting device may further include an electric resistance adjusting layer that is formed so as to be sandwiched between at least either one of the first and second electrodes and the phosphor layer, and has an electric resistance value that is varied in the longitudinal direction. The electric resistance adjusting layer may have a film thickness that is varied in the longitudinal direction.

The transparent electrode may have a terminal to be connected to a power supply that is formed on one of end portions of two ends thereof in the longitudinal direction.

The first semiconductor substance and the second semiconductor substance may have semiconductor structures with mutually different conductive types. The first semiconductor substance may have an n-type semiconductor structure and the second semiconductor substance may have a p-type semiconductor structure.

The first semiconductor substance and the second semiconductor substance may be compound semiconductors respectively. The first semiconductor substance may be a compound semiconductor consisting of Group 12 and Group 16.

The first semiconductor substance may have a cubic crystal structure.

The first semiconductor substance includes at least one kind of element selected from the group consisting of Cu, Ag, Au, Ir, Al, Ga, In, Mn, Cl, Br, I, Li, Ce, Pr, Nd, Pm, Sm, Eu, Gd, Tb, Dy, Ho, Er, Tm and Yb.

The polycrystalline structure, made from the first semiconductor substance, may have an average crystal grain size in a range from 5 to 500 nm.

The second semiconductor substance includes at least one kind of compound selected from the group consisting of Cu₂S, ZnS, ZnSe, ZnSSe, ZnSeTe, ZnTe, GaN and InGaN.

The first semiconductor substance may be a zinc-based material containing simple zinc. In this case, at least one of the electrodes is preferably made from a material containing zinc. Here, the material containing zinc that forms one of the electrodes is mainly composed of zinc oxide, and may contain at least one kind selected from the group consisting of aluminum, gallium, titanium, niobium, tantalum, tungsten, copper, silver and boron.

A linear light-emitting device according to the present invention includes: a pair of first and second linear electrodes opposing each other; and

a linear phosphor layer sandwiched between the paired electrodes,

wherein at least one of the paired first and second electrodes is a transparent electrode, and the phosphor layer has a p-type semiconductor and an n-type semiconductor.

The phosphor layer may have a structure in which n-type semiconductor particles are dispersed in a medium made from a p-type semiconductor. The phosphor layer may be formed by an aggregated body of n-type semiconductor particles, with the p-type semiconductor being segregated between the particles.

The n-type semiconductor particles may be electrically jointed to the first and second electrodes through the p-type semiconductor.

The phosphor layer may have an electric resistance value between the first and second electrodes that is varied in a longitudinal direction.

The phosphor layer may be divided into a plurality of regions by a plurality of insulators placed between the paired electrodes.

The phosphor layer may have a film thickness that is varied in the longitudinal direction.

The linear light-emitting device may further include an electric resistance adjusting layer that is formed so as to be sandwiched between at least either one of the first and second electrodes and the phosphor layer, and has an electric resistance value that is varied in the longitudinal direction.

The electric resistance adjusting layer may have a film thickness that is varied in the longitudinal direction.

The transparent electrode may have a terminal to be connected to a power supply that is formed on one of end portions of two ends thereof in the longitudinal direction.

The n-type semiconductor and the p-type semiconductor may be compound semiconductors respectively. The n-type semiconductor may be a compound semiconductor consisting of Group 12 and Group 16. The n-type semiconductor may be a compound semiconductor consisting of Group 12 and Group 16. The n-type semiconductor may be a chalcopyrite type compound semiconductor.

The n-type semiconductor may be at least one kind of compound selected from the group consisting of ZnS, ZnSe, ZnSSe, ZnSeTe, ZnTe, GaN and InGaN.

The n-type semiconductor may be a zinc-based material containing zinc. In this case, at least either one of the first and second electrodes is preferably made from a material containing zinc. The material containing zinc that forms one of the electrodes is mainly composed of zinc oxide, and preferably contains at least one kind selected from the group consisting of aluminum, gallium, titanium, niobium, tantalum, tungsten, copper, silver and boron.

The linear light-emitting device may further include a supporting substrate that faces at least one of the electrodes and supports the device. In addition, the linear light-emitting device may further include a color conversion layer that faces the respective electrodes, and is placed in front of the direction in which light is emitted.

A plane light source according to the present invention includes the linear light-emitting device described above; and

a light guide plate that reflects linear light outputted from the linear light-emitting device to form planar light.

In accordance with the present invention, it becomes possible to provide a linear light-emitting device that uses a light-emitting element having a long service life and high light emission luminance.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1A is a schematic cross-sectional view that shows a structure of a linear light-emitting device in accordance with first embodiment of the present invention; and FIG. 1B is a schematic cross-sectional view that shows a structure of another linear light-emitting device;

FIG. 2A is a front elevational view showing a structure of a plane light source using the linear light-emitting device in accordance with first embodiment of the present invention, viewed in a direction perpendicular to a light-emitting direction; and FIG. 2B is a plan view showing the plane light source viewed in the light-emitting direction;

FIG. 3 is a cross-sectional view that shows a detailed structure of a phosphor layer of the linear light-emitting device of FIG. 1;

FIG. 4A is a schematic diagram that shows the vicinity of an interface between a phosphor layer made from ZnS and a transparent electrode (or a back electrode) made from AZO; and FIG. 4B is a schematic diagram that explains a displacement of potential energy of FIG. 4A;

FIG. 5A, which shows a comparative example, is a schematic diagram that shows an interface between a phosphor layer made from ZnS and a transparent layer made from ITO; and FIG. 5B is a schematic diagram that explains a displacement of potential energy of FIG. 5A;

FIGS. 6A and 6B are schematic views that show nonuniformity of current density depending on terminal positions of a linear light-emitting device;

FIG. 7 is a schematic cross-sectional view that shows a structure of a linear light-emitting device in accordance with second embodiment of the present invention;

FIG. 8 is a cross-sectional view that shows luminance in each of regions divided in a phosphor layer of the linear light-emitting device in accordance with second embodiment of the present invention;

FIG. 9 is a schematic cross-sectional view that shows a structure of another linear light-emitting device;

FIG. 10 is a cross-sectional view that shows a structure of a linear light-emitting device in accordance with third embodiment of the present invention;

FIG. 11 is a schematic view that shows a structure of a manufacturing device for the linear light-emitting device in accordance with third embodiment of the present invention;

FIG. 12 is a cross-sectional view that shows a structure of a linear light-emitting device in accordance with fourth embodiment of the present invention;

FIG. 13A is a schematic cross-sectional view that shows a structure of a linear light-emitting device in accordance with fifth embodiment of the present invention; and FIG. 13B is a schematic cross-sectional view that shows another linear light-emitting device;

FIG. 14A is a front elevational view that shows a structure of a plane light source using the linear light-emitting device in accordance with fifth embodiment of the present invention, viewed in a direction perpendicular to a light-emitting direction; and FIG. 14B is a plan view showing the plane light source viewed in the light-emitting direction;

FIG. 15 is a cross-sectional view that shows a detailed structure of a phosphor layer of the linear light-emitting device of FIG. 13;

FIG. 16 is a cross-sectional view of another linear light-emitting device;

FIG. 17 is a cross-sectional view of still another linear light-emitting device;

FIG. 18A is a schematic diagram that shows the vicinity of an interface between a phosphor layer made from ZnS and a transparent electrode (or a back electrode) made from AZO; and FIG. 18B is a schematic diagram that explains a displacement of potential energy of FIG. 18A;

FIG. 19A, which shows a comparative example, is a schematic diagram that shows an interface between a phosphor layer made from ZnS and a transparent layer made from ITO; and FIG. 19B is a schematic diagram that explains a displacement of potential energy of FIG. 19A;

FIGS. 20A and 20B are schematic views that show nonuniformity of current density depending on terminal positions of a linear light-emitting device;

FIG. 21 is a schematic cross-sectional view that shows a structure of a linear light-emitting device in accordance with sixth embodiment of the present invention;

FIG. 22 is a cross-sectional view that shows luminance in each of regions divided in a phosphor layer of the linear light-emitting device in accordance with sixth embodiment of the present invention;

FIG. 23 is a schematic cross-sectional view that shows a structure of another linear light-emitting device;

FIG. 24 is a cross-sectional view that shows a structure of a linear light-emitting device in accordance with seventh embodiment of the present invention;

FIG. 25 is a schematic view that shows a structure of a manufacturing device for the linear light-emitting device in accordance with seventh embodiment of the present invention;

FIG. 26 is a cross-sectional view that shows a structure of a linear light-emitting device in accordance with eighth embodiment of the present invention; and

FIG. 27 is a schematic cross-sectional view that shows a conventional inorganic EL element viewed in a direction perpendicular to the light-emitting face thereof.

### DETAILED DESCRIPTION OF THE PREFERRED EMBODIMENTS

A best mode for carrying out the invention will be described with reference to the attached drawings. Here, in the drawings, those members that are substantially the same are indicated by the same reference numerals, and the description thereof is not given.

### First Embodiment

### <Schematic Structure of Linear Light-Emitting Device>

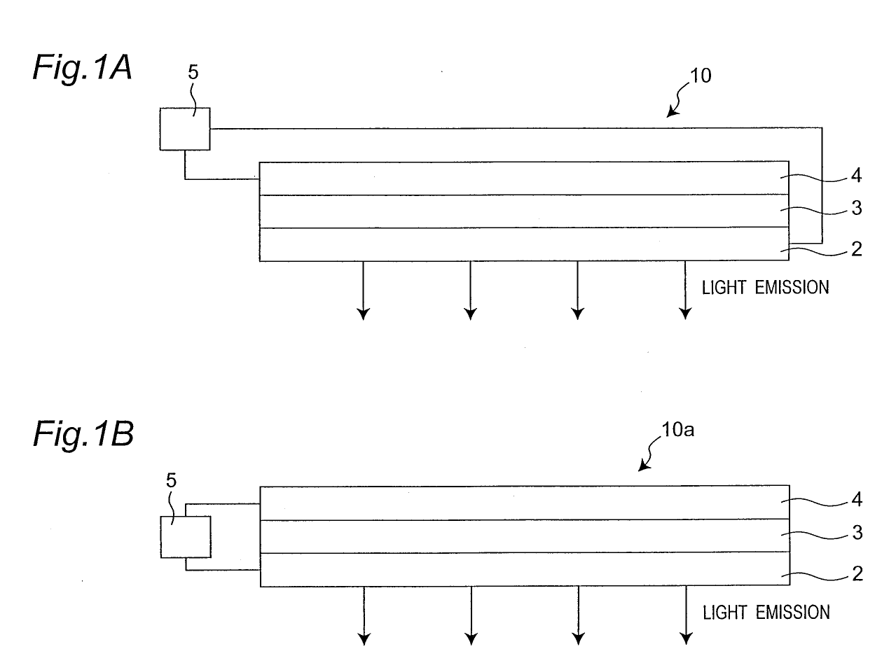

FIG. 1A is a cross-sectional view that schematically shows a linear light-emitting device 10 in accordance with first embodiment of the present invention. FIG. 1B) is a cross-sectional view that shows another linear light-emitting device 10a. This linear light-emitting device 10 is provided with a linear phosphor layer 3, and a pair of a transparent electrode 2 and a back electrode (metal electrode) 4 that are aligned in a longitudinal direction, with the phosphor layer 3 being sandwiched therebetween. The transparent electrode 2 and the back electrode (metal electrode) 4 are electrically connected to each other with a power supply 5 interposed therebetween. In this case, the transparent electrode 2, connected to the negative electrode side, functions as an electron injecting electrode (second electrode), and the back electrode (metal electrode) 4, connected to the positive electrode side, functions as a hole injecting electrode (first electrode). Here, the linear light-emitting device 10 of FIG. 1A has a structure in which terminals that connect respective electrodes 2 and 4 with a power supply are formed on the respectively different shorter sides, while the linear light-emitting device 10a of FIG. 1B has a structure in which terminals that connect the respective electrodes 2 and 4 with the power supply are formed on the same shorter side, and these light-emitting devices are different from each other in this point.

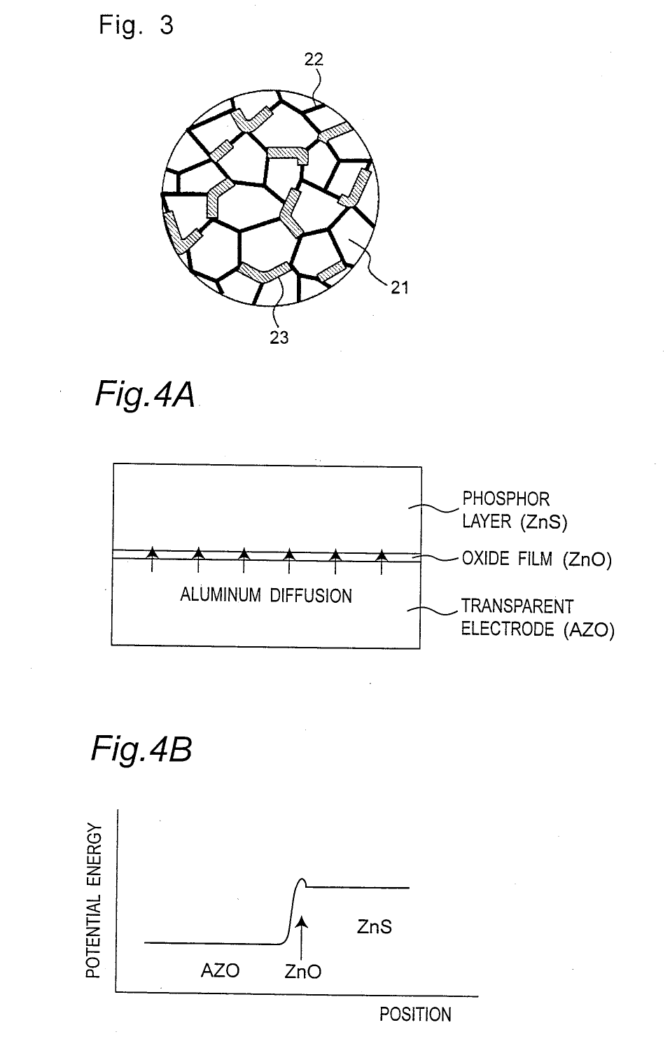

FIG. 3 is a schematic enlarged view of the phosphor layer 3. In this linear light-emitting device 10, as shown in FIG. 3, the phosphor layer 3 has a polycrystalline structure made from a first semiconductor substance 21 in which a second semiconductor substance 23 is segregated to a grain boundary 22 of this polycrystalline structure. In the present embodiment, the first semiconductor substance 21 is an n-type semiconductor substance, and the second semiconductor substance 23 is a p-type semiconductor substance. In this manner, the p-type semiconductor substance segregated on the grain boundary of the n-type semiconductor substance makes it possible to improve the hole injecting property and consequently to efficiently generate light emission of a recombination type between electrons and holes; thus, light emission is available at a low voltage so that it is possible to achieve a linear light-emitting device 10 capable of emitting light with high luminance.

Moreover, in the linear light-emitting device 10, the transparent electrode 2 and the back electrode 4 are electrically connected to each other with a DC power supply 5 interposed therebetween. When power is supplied from the DC power supply 5, a potential difference is exerted between the transparent electrode 2 and the back electrode 4 so that a voltage is applied on the phosphor layer 3. Thus, the phosphor layer 3, disposed between the transparent electrode 2 and the back electrode 4, is allowed to emit light, and the light transmits through the transparent electrode 2 and is extracted from the linear light-emitting device 10.

Here, not limited by the above-mentioned structure, the following modifications may be made on demand: a plurality of dielectric layers are formed between the electrode and the phosphor layer in order to regulate the electric current, a driving operation is carried out by using an AC power supply, a transparent back electrode is used, a black electrode is used as the back electrode, a structure that seals the entire or a part of the linear light-emitting device 10 is further provided, and a structure for converting the color of light emission from the phosphor layer 3 is placed on the front side of the light emitting direction. For example, a blue-color phosphor layer and a color-converting layer that converts blue color into green color and red color can be combined with each other to produce a white-color linear light-emitting device.

The respective structures of this linear light-emitting device will be described below.

Here, FIG. 1 has exemplified a structure in which the phosphor layer 3 is sandwiched by the paired electrodes 2 and 4, without using a substrate; however, a substrate 1 for supporting the entire structure may be formed. For example, another structure may be used in which the transparent electrode 2 is formed on the substrate 1, and the phosphor layer 3 and the back electrode 4 are successively laminated thereon.

### <Substrate>

A material that can support respective layers formed thereon is used as the substrate 1. Moreover, the material needs to have a light transmitting property to a light wavelength that is emitted from an illuminant of the phosphor layer 3. Examples of the material include glass, such as corning 1737, quartz, ceramics and the like. In order to prevent alkaline ion or the like, contained in normal glass, from giving adverse effects to the light-emitting element, non-alkaline glass, or soda lime glass, formed by coating alumina or the like as an ion barrier layer on the glass surface, may be used. Moreover, a combination of resins, such as a polyester-based, polyethylene terephthalate-based, or polychlorotrifluoroethylene-based resin and nylon 6, a fluororesine-based material, and a resin film, such as polyethylene, polypropylene, polyimide and polyamide, may also be used. Those resin films having superior durability, flexibility, transparency, electrical insulating property, and moisture-preventive property, are preferably used. These are only examples, and the material of the substrate 1 is not intended to be limited by these.

Moreover, in the case of a structure in which no light is taken out from the substrate side, the above-mentioned light transmitting property is not required, and a material having no light transmitting property may also be used.

### <Electrode>

The electrodes include the transparent electrode 2 on the side from which light is taken out and the back electrode 4 on the other side. Here, another structure may be used in which the transparent electrode 2 is formed on the substrate 1 and the phosphor layer 3 and the back electrode 4 are formed successively thereon. In contrast, still another structure may be used in which the back electrode 4 is formed on the substrate 1 and the phosphor layer 3 and the transparent electrode 2 are formed successively thereon. Alternatively, both of the transparent electrode 2 and the back electrode 4 may be formed as transparent electrodes.

First, the transparent electrode 2 is explained. Any material may be used as the transparent electrode 2 as long as it has a light-transmitting property so as to take light emission generated in the phosphor layer 3 out of the layer, and in particular, those materials having a high transmittance within a visible light range are desirably used. Moreover, those materials that have low resistance when used as the electrode are preferably used, and in particular, those materials having a superior adhesive property to the substrate 1 and the phosphor layer 3 are desirably used. In particular, preferred examples of materials for the transparent electrode 2 include those ITO materials (In₂O₃ doped with SnO₂, referred to also as indium tin oxide), metal oxides mainly composed of InZnO, ZnO, SnO₂ or the like, metal thin films such as Pt, Au, Pd, Ag, Ni, Cu, Al, Ru, Rh, and Ir, and conductive polymers, such as polyaniline, polypyrrole, PEDOT/PSS and polythiophene, and the like; however, the material is not particularly limited by these. These transparent electrodes 2 may be formed by using a film-forming method, such as a sputtering method, an electron beam vapor deposition method and an ion plating method so as to improve the transparency thereof or to lower the resistivity thereof. Moreover, after the film-forming process, the film may be surface-treated by a plasma treatment or the like so as to control the resistivity thereof. The film thickness of the transparent electrode 2 is determined based upon the sheet resistance value and visible light transmittance to be required.

The carrier concentration of the transparent electrode 2 is preferably set in a range from 1E17 to 1E22 cm⁻³. Moreover, in order to obtain performances as the transparent electrode 2, the volume resistivity of the transparent electrode 2 is preferably set to 1E-3 Ω·cm or less, and the transmittance is preferably set to 75% or more in a wavelength range from 380 to 780 nm. Furthermore, the refractive index of the transparent electrode 2 is preferably set to 1.85 to 1.95. Furthermore, in general, the film thickness of the transparent electrode 2 is set from approximately 100 to 200 nm. Here, in the case of a film such as ZnO, when the film thickness is set to 30 nm or less, it becomes possible to achieve a solid film with stable characteristics.

Moreover, any of generally well-known conductive materials may be applied as the back electrode 4. Preferably, those materials that are superior in adhesion to the phosphor layer 3 are preferably used. Preferred examples thereof include metal oxides, such as ITO, InZnO, ZnO and SnO₂, metals, such as Pt, Au, Pd, Ag, Ni, Cu, Al, Ru, Rh, Ir, Cr, Mo, W, Ta and Nb, and laminated products thereof, or conductive polymers, such as polyaniline, polypyrrole and PEDOT[poly(3,4-ethylenedioxythiophene)]/PSS(polystyrene sulfonate), or conductive carbon.

### <Phosphor Layer>

The phosphor layer 3 will be described below. FIG. 3 is a schematic structural view in which one portion of the cross section of the phosphor layer 3 is enlarged. The phosphor layer 3 has a polycrystalline structure made from the first semiconductor substance 21, in which the second semiconductor substance 23 is segregated on the grain boundary 22 of the polycrystalline structure. As the first semiconductor substance 21, a semiconductor material that has majority carriers composed of electrons, and exhibits an n-type conductivity is used. On the other hand, as the second semiconductor substance 23, a semiconductor material that has majority carriers composed of holes, and exhibits a p-type conductivity is used. Here, the first semiconductor substance 21 and the second conductive substance 23 are electrically joined to each other.

As the first semiconductor substance 21, those materials having a band gap size ranging from a near ultraviolet area to a visible light area (from 1.7 eV to 3.6 eV) are preferably used, and more preferably, those materials having a band gap size ranging from the near ultraviolet area to a blue color area (from 2.6 eV to 3.6 eV) are used. Specific examples thereof include: the aforementioned compounds consisting of Group 12 and Group 16 elements, such as ZnS, ZnSe, ZnTe, CdS and CdSe, and mixed crystals of these (for example, ZnSSe or the like), compounds consisting of Group 2 and Group 16 elements, such as CaS and SrS, and mixed crystals of these (for example, CaSSe or the like), compounds consisting of Group 13 and Group 15 elements, such as AlP, AlAs, GaN and GaP, and mixed crystals of these (for example, InGaN or the like), and mixed crystals of the above-mentioned compounds, such as ZnMgS, CaSSe and CaSrS. Moreover, chalcopyrite-type compounds, such as CuAIS₂, may be used. Furthermore, as the polycrystalline material made of the first semiconductor substance 21, those having a cubic crystal structure in the main portion thereof are preferably used. Here, one or a plurality of kinds of atoms or ions, selected from the group consisting of the following elements, may be contained as additives: Cu, Ag, Au, Ir, Al, Ga, In, Mn, Cl, Br, I, Li, Ce, Pr, Nd, Pm, Sm, Eu, Gd, Tb, Dy, Ho, Er, Tm and Yb. The light emission color from the phosphor layer 3 is also determined by the kinds of these elements.

Here, as the second semiconductor substance 23, any one of Cu₂S, ZnS, ZnSe, ZnSSe, ZnSeTe, ZnTe, GaN and InGaN may be used. These materials may contain one kind or plural kinds of elements, selected from N, Cu and In, as additives used for imparting the p-type conductivity thereto.

The feature of the linear light-emitting device 10 relating to first embodiment lies in that the phosphor layer 3 has a polycrystalline structure made from the n-type semiconductor substance 21, with the p-type semiconductor substance 23 being segregated on the grain boundary 22 of the polycrystalline structure. In the conventional inorganic EL, by enhancing the crystallinity of the phosphor layer, electrons accelerated by a high electric field are prevented from being diffused; however, in general, since ZnS, ZnSe or the like exhibits the n-type conductivity, a supply of holes is not sufficient, with the result that light emission with high luminance derived from a recombination of an electron and a hole is not expected. In contrast, when the crystal grains of the phosphor layer are grown, the crystal grain boundary is uniquely expanded as well, unless it is a single crystal. In the case of a conventional inorganic EL element to which a high voltage is applied, the grain boundary in the film thickness direction forms a conductive path, resulting in a problem of a reduction in withstand voltage. In contrast, after hard studies, the inventor has found that, in a phosphor layer 3 having a polycrystalline structure made from the n-type semiconductor substrate 21, by providing a structure in which the p-type semiconductor substance 23 is segregated on the grain boundary 22 of the polycrystalline structure, the injecting property of holes is improved by the p-type semiconductor substance segregated on the grain boundary. Moreover, the inventor has also found that by scattering the segregated portions in the phosphor layer 3 with a high concentration, the recombination-type light emission of electrons and holes can be efficiently generated. Thus, it becomes possible to achieve a light-emitting element that emits light with high luminance at a low voltage, and consequently to complete the present invention. Moreover, by introducing a donor or an acceptor thereto, free electrons and holes captured by acceptors can be recombined, free holes and electrons captured by donors can be recombined, and light emission of the paired donor and acceptor can also take place. Furthermore, since other kinds of ions are located closely, light emission derived from energy transfer can also occur.

Moreover, in the case where a zinc-based material such as ZnS is used as the n-type semiconductor particles 21 of the phosphor layer 3, an electrode, made from a metal oxide containing zinc, such as ZnO, AZO (zinc oxide doped with, for example, aluminum) and GZO (zinc oxide doped with, for example, gallium), is preferably used as at least one of the transparent electrode 2 and the back electrode 4. The inventor has found that, by adopting a combination of specific n-type semiconductor particles 21 and a specific transparent electrode 2 (or back electrode 4), light emission can be produced with high efficiency.

Specifically, paying attention to a work function in the transparent electrode 2 (or back electrode 4), the work function of ZnO is 5.8 eV, while the work function of ITO (indium-tin oxide) that has been conventionally used as the transparent electrode is 7.0 eV. Here, since the work function of a zinc-based material that is the n-type semiconductor particles 21 of the phosphor layer 3 is 5 to 6 eV, the work function of ZnO is closer to the work function of the zinc-based material in comparison with that of ITO; therefore, the resulting advantage is that the electron injecting property to the phosphor layer 3 is improved. The same is true in the case where AZO or GZO, which is a zinc-based material, is used as the transparent electrode 2 (or back electrode 4) in the same manner.

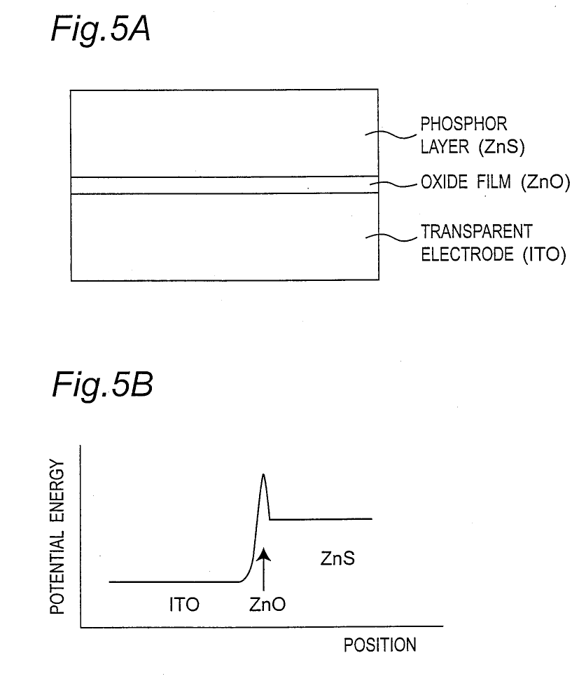

FIG. 4A is a schematic diagram that shows the vicinity of an interface between the phosphor layer 3 made from ZnS and the transparent electrode 2 (or back electrode 4) made from AZO. FIG. 4B is a schematic diagram that explains the change of potential energy of FIG. 4A. Moreover, FIG. 5A, which shows a comparative example, is a schematic diagram that shows an interface between a phosphor layer 3 made from ZnS and a transparent electrode made from ITO. FIG. 5B is a schematic diagram that explains the change of potential energy of FIG. 5A.

As shown in FIG. 4A, in the above-mentioned preferred example, since the n-type semiconductor substrate 21 forming the phosphor layer 3 is made from a zinc-based material (ZnS) and since the transparent electrode 2 (or back electrode 4) is made from a zinc oxide-based material (AZO), an oxide to be formed on the interface between the transparent electrode 2 (or back electrode 4) and the phosphor layer 3 is a zinc oxide (ZnO). Moreover, on the interface, upon forming a film, the doping material (Al) is diffused so that a low resistance oxide film is formed. Moreover, the zinc oxide-based (AZO) transparent electrode 2 (or back electrode 4) has a crystal structure in a hexagonal system, and since the zinc-based material (ZnS) serving as the n-type semiconductor substance 21 forming the phosphor layer 3 also has a hexagonal crystal or a crystal structure in a cubic system, a strain to be exerted on the interface of the two layers is small to cause a small energy barrier. Consequently, as shown in FIG. 4(b), the change in potential energy becomes smaller.

In a comparative example, on the other hand, as shown in FIG. 5A, since the transparent electrode is made from ITO that is not a zinc-based material, the oxide film (ZnO) formed on the interface has a different crystal structure from that of ITO so that an energy barrier on the interface becomes larger. Therefore, as shown in FIG. 5B, the change in the potential energy becomes greater on the interface to cause a reduction in the light emitting efficiency of the light-emitting device.

As described above, in the case where a zinc-based material, such as ZnS and ZnSe, is used as the n-type semiconductor particles 21 of the phosphor layer 3, by combining the particles with the transparent electrode 2 (or back electrode 4) made from a zinc oxide-based material, it becomes possible to provide a linear light-emitting device having superior light emitting efficiency.

Here, in the above-mentioned example, the explanation has been given by exemplifying AZO doped with aluminum and GZO doped with gallium as the transparent electrode 2 (or back electrode 4) containing zinc; however, the same effects can be obtained even by using zinc oxide doped with at least one kind selected from the group consisting of aluminum, gallium, titanium, niobium, tantalum, tungsten, copper, silver and boron.

### <Manufacturing Method>

One example of a method for manufacturing the linear light-emitting device 10, in accordance with first embodiment, will be described. Here, the same manufacturing method may be applicable to a phosphor layer made from another material as described above.

(a) First, Corning 1737 is prepared as a substrate 1.
(b) A linear back electrode 4 is formed on the substrate 1. For example, Al is used, and this is formed by using a photolithography method. The film thickness is set to 200 nm.
(c) A linear phosphor layer 3 is formed on the back electrode 4. Powdered ZnS and Cu₂S are respectively charged into a plurality of evaporating sources, and each of the material is irradiated with an electron beam under vacuum (about 10⁻⁶ Torr) so as to be film-formed thereon. At this time, the substrate temperature is set to 200° C. so that ZnS and Cu₂S are vapor deposited together.
(d) After forming the film, this is subjected to an annealing process at 700° C. for about one hour in a sulfur atmosphere so that a linear phosphor layer 3 is obtained. By examining this film by using the X-ray diffraction and the SEM, the polycrystalline structure with minute ZnS crystal grains and the segregated portion of CuₓS on its grain boundary can be observed. Although the reason for this has not been clarified, it is considered that a phase separation occurs between ZnS and CuₓS, with the result that the above-mentioned segregated structure is formed.
(e) Successively, a linear transparent electrode 2 is formed by using, for example, ITO. The film thickness is set to 200 nm.
(f) Next, a transparent insulator layer made from, for example, silicon nitride or the like is formed on the phosphor layer 3 and the transparent electrode 2 as a protective layer (not shown in the figure).

By using the above-mentioned processes, a linear light-emitting device 10 of first embodiment is obtained.

In the linear light-emitting device 10 of first embodiment, the transparent electrode 2 and the back electrode 4 were connected to a DC power supply 5, with a DC voltage being applied therebetween, so that light emission evaluations were carried out, and as a result, light emission was initiated at an applied voltage of 15 V, and a light emission luminance of about 600 cd/m² was exerted at 35 V

### <Plane Light Source>

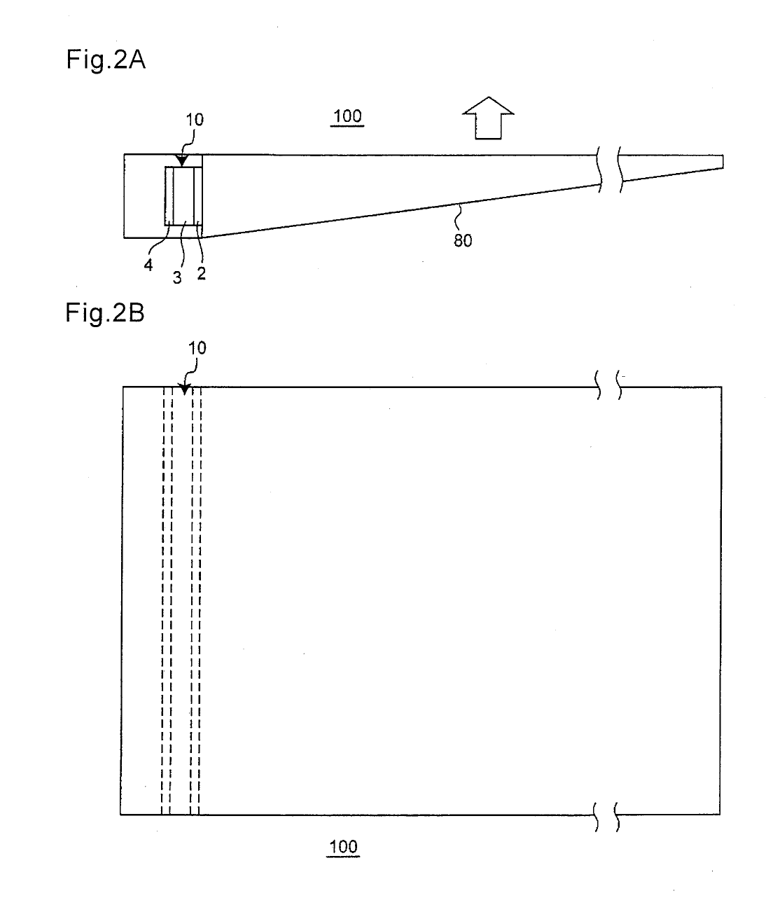

FIG. 2A is a front elevational view showing a structure of a plane light source 100 in which the linear light-emitting device 10 in accordance with first embodiment of the present invention is used, and FIG. 2B is a plan view thereof. This plane light source 100 is provided with the linear light-emitting device 10 of first embodiment and a light-guide plate 80 that reflects linear light outputted from the linear light-emitting device 10 so as to be formed into planar light. In this plane light source 100, linear light outputted from the linear light-emitting device 10 is reflected by a face of the light-guide plate 80 of FIG. 2A on the lower side on the drawing face, and is taken out from a face on the upper side on the drawing face as the planar light. The linear light-emitting device 10 is disposed with its longitudinal direction being made in parallel with the light-emitting face of the plane light source 100 from which the planar light is taken out. Moreover, the output direction of linear light of the linear light-emitting device 10 is made in parallel with the light-emitting face of the plane light source 100 from which the planar light is taken out. The light-guide plate 80 is disposed in a slightly tilted manner so as to make an acute angle with the light-emitting face of the plane light source 100 from which the planar light is taken out.

In accordance with this plane light source 100, since the linear light-emitting device 10 relating to first embodiment is used, and since the device is arranged in combination with the light-guide plate 80 that changes the linear light outputted from the linear light-emitting device 10 into the planar light, a thinner device can be achieved at a low cost.

Here, the linear light-emitting device using the above-mentioned inorganic EL light-emitting element causes a reduction in electric resistance of the phosphor layer. For this reason, in the case where the phosphor layer, as it is, is used with a large surface area, as a plane light source for a backlight for use in, for example, a liquid crystal display or the like, too much current tends to flow, making it difficult to use this as the plane light source. Therefore, in the case where the linear light-emitting device is used as a backlight or the like, a linear light-source type use in combination with a light-guide plate like a cold cathode-ray tube, as described above, or a dot light-source type use like an LED, is preferably adopted.

### Second Embodiment

### <Schematic Structure of Linear Light-Emitting Device>

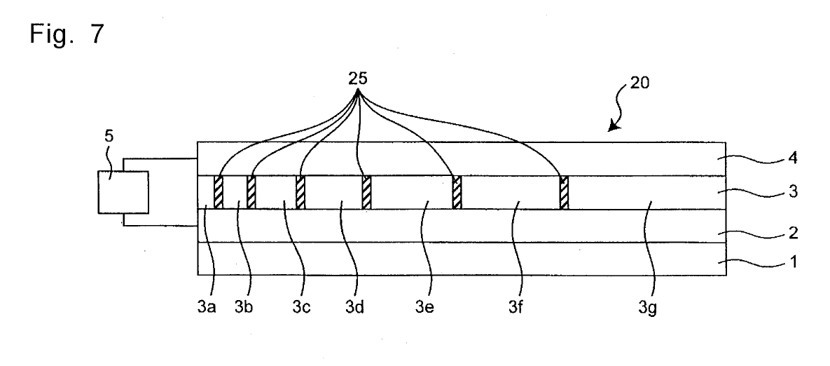

FIG. 7 is a cross-sectional view that schematically shows a linear light-emitting device 20 in accordance with second embodiment of the present invention, viewed in a direction perpendicular to the light-emitting face with respect to the longitudinal direction thereof. This linear light-emitting device 20 functions as a linear light source. This linear light-emitting device 20 is configured by a substrate 1, a transparent electrode 2, a phosphor layer 3 and a metal electrode 4, and the phosphor layer 3 is characterized by being electrically divided into regions 3a to 3g in the longitudinal direction by a plurality of insulators 25. Here, a metal electrode is used as the back electrode 4. Moreover, in this linear light-emitting device 20, a voltage is applied between the transparent electrode 2 and the metal electrode 4 by a power supply 5 so that the phosphor layer 3 is allowed to emit light, and the light is taken out from the substrate 1 side. In this linear light-emitting device 20, by electrically dividing the phosphor layer 3 into a plurality of regions along the longitudinal direction, a plurality of electrical paths that extend from the transparent electrode 2 to reach the metal electrode 4 through the respective regions 3a to 3g divided in the phosphor layer 3 are allowed to have virtually the same electric resistance value so that it becomes possible to provide uniform luminance in the longitudinal direction.

### <Featured Portion of Linear Light-Emitting Device of the Present Second Embodiment>

The linear light-emitting device 20 in accordance with second embodiment of the present invention has a featured portion in structure in which the phosphor layer 3 is electrically divided into respective regions 3a to 3g along the longitudinal direction by a plurality of insulators 25. By finding out the following problems with the linear light-emitting device relating to first embodiment, the present inventor has reached the above-mentioned new feature so as to solve the problems.

The following description will explain the problems with the linear light-emitting device relating to first embodiment found by the present inventor, and then explain how the problems can be solved by the feature of the present invention.

<Problems with Linear Light-Emitting Device Relating to First Embodiment>

First, the present inventor has found a problem of luminance non-uniformity in the case where a linear light-emitting device of first embodiment is used as a linear light source. Specifically, since the electric resistance of the phosphor layer 3 is low, a comparatively large electric current flows upon light emission, and this causes a voltage drop in the transparent electrode 2 having a comparatively high resistance value, with the result that the current value of each of paths that pass through the respective portions of the phosphor layer 3 becomes gradually smaller from a terminal corresponding to a contact point from a power supply in the longitudinal direction of the transparent electrode 2 to cause a problem of low uniformity in luminance.

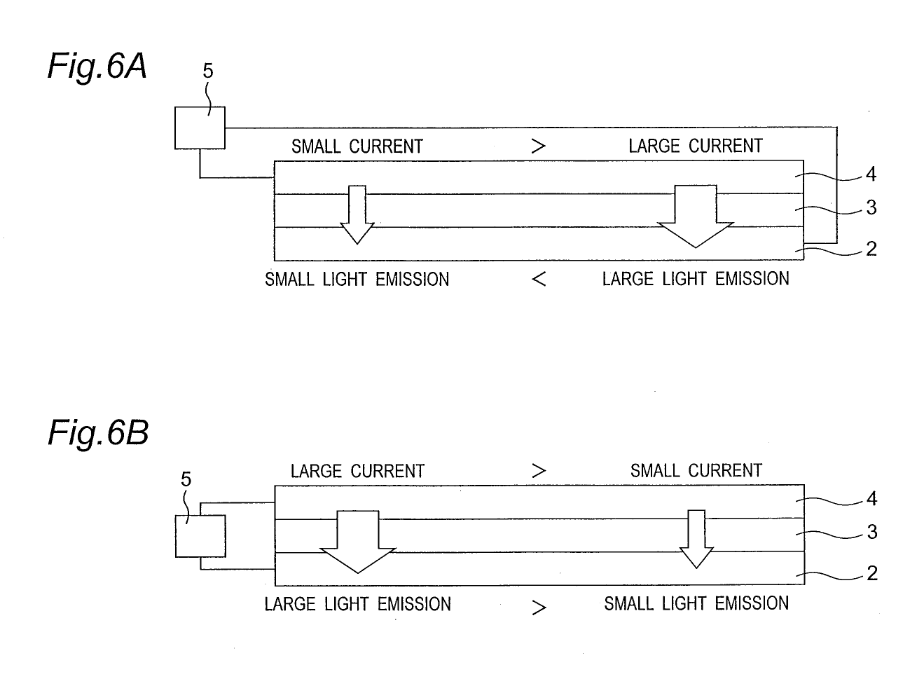

Referring to FIGS. 6A and 6B, the above-mentioned problem is further explained. FIGS. 6A and 6B are schematic cross-sectional views that briefly show the structure of a linear light-emitting device (from which substrates and the like are omitted). In the linear light-emitting device of FIG. 6A, respective terminals from a power supply 5 to two electrodes 2 and 4 are wired to respectively different shorter sides of the two ends in the longitudinal direction; in contrast, in the linear light-emitting device of FIG. 6B, respective terminals to the two electrodes 2 and 4 are wired to the same shorter side. The linear light-emitting devices are allowed to emit light when power is supplied to the respective electrodes 2 and 4 from the power supply 5 through the respective terminals. Here, the flow of an electric current in the linear light-emitting device will be described below. First, with respect to the resistance values of the respective electrodes 2 and 4, the specific resistance value of a material forming the metal electrode 4 is extremely lower than the specific resistance value of a material forming the transparent electrode 2. Next, with respect to the resistance value of the phosphor layer 3, the distance between the transparent electrode 2 and the metal electrode 4 in a current-flowing direction is sufficiently thin because of the thin-film phosphor layer 3, and since the specific resistance value of a material forming the phosphor layer is low in comparison with that of a material forming a conventional phosphor layer, the inside of the phosphor layer 3 has a low resistance value. Moreover, since the thickness of the phosphor layer 3 is substantially uniform in the longitudinal direction, the resistance value inside the phosphor layer 3 is kept substantially uniform in the longitudinal direction. Consequently, in the linear light-emitting device, the specific resistance value of the transparent electrode 2 gives greater influences to the distribution of an electric current flowing through the phosphor layer. Specifically, more electric current flows where there is less resistance; therefore, as the distance in the transparent electrode 2 through which the electric current flows becomes shorter, more electric current is allowed to flow. Here, in the phosphor layer 3, as the electric current becomes higher, the light-emission luminance becomes higher. In other words, as the distance from the terminal corresponding to a contact point from the power supply 5 in the longitudinal direction of the transparent electrode 2 becomes longer, the electric current value flowing through the phosphor layer 3 becomes gradually smaller to cause the light-emission luminance of the phosphor layer 3 becomes gradually smaller. In particular, in the phosphor layer 3 of the present embodiment made from a material having a lower resistance value in comparison with that of the material forming a conventional phosphor layer, the value of the electric current flowing at the time of light emission becomes greater, and the influences of a voltage drop in the transparent electrode 2 also become greater. Moreover, the difference between the quantity of the electric current and the quantity of light emission becomes greater between the side of the transparent electrode 2 closer to the terminal corresponding to the contact point from the power supply and the side thereof farther from the terminal in the longitudinal direction. Therefore, in the linear light-emitting device of FIG. 6A, the luminance on the right side in the longitudinal direction becomes higher than that on the left side, while, in the linear light-emitting device of FIG. 6B, the luminance on the left side in the longitudinal direction becomes higher than that on the right side. Here, arrows shown in FIG. 6 are given by imaging the quantity of electric current, and do not represent the direction or quantity of the electric current.

The featured point of the linear light-emitting device 20 relating to the present second embodiment has been devised so as to solve the problem that, when a linear light-emitting device is used as a linear light source, the uniformity in luminance in the longitudinal direction is lowered. In other words, in the present invention, in a plurality of paths that extend through the phosphor layer 3 between the paired electrodes 2 and 4 of the linear light-emitting device, by changing the inner resistance values of the respective paths depending on respective portions thereof, it becomes possible to solve the problem with the uniformity in luminance.

The structure of the phosphor layer 3 in this linear light-emitting device 20 will be described bellow. This phosphor layer 3 is electrically divided into a plurality of regions 3a to 3g by a plurality of insulators 25. First, the insulators 25 will be explained, and next, the layout of the insulators will be explained.

### <Insulators>

The insulators 25 are formed in the phosphor layer 3, and used for electrically dividing the phosphor layer 3 into the regions 3a to 3g. As the material for the insulators 25, for example, insulating materials, such as, oxide insulators like SiO₂ and Al₂O₃, and plastic resins, may be used, although not particularly limited thereby.

Moreover, the insulators 25 may be formed by using the following processes.

a) A phosphor layer 3 is formed by using a predetermined method.
b) The phosphor layer 3, thus formed, is subjected to an etching process at its portions where the insulators 25 are to be formed later, by using a photolithography method or the like.
c) In the case where, for example, SiO₂ is embedded into the etched concave portions as the insulators 25, the embedding process is carried out by using a sputtering method, and in the case where a resin is embedded therein as the insulators 25, the embedding process is carried out by using a coating method.
d) Thereafter, the insulators on the upper portion of the phosphor layer 3 are removed by etching or grinding.

The insulators 25 can be disposed inside the phosphor layer 3 by the above-mentioned processes.

Here, not limited to the above-mentioned method, another method may be used in which the insulators 25 are preliminarily formed on the transparent electrode 2, and after patterning the insulators 25 by using a photolithography method or the like, the phosphor layer 3 is formed thereon, and the phosphor layer 3 on the upper portion of the insulators 25 is smoothed by grinding or the like so that regions 3a to 3g, formed by dividing the phosphor layer 3 with the insulators 25, may be obtained.

### <Layout of Insulators>

The layout of the insulators 25 inside the phosphor layer 3 will be described below. The intervals of the insulators 25 are determined depending on electric resistance values of the respective paths. The intervals are determined so that the electric resistance values in the paths each of which extends from the power supply 5 through the terminal serving as the contact point to the power supply 5, formed on the transparent electrode 2, and the transparent electrode 2 and the phosphor layer 3 to reach the metal electrode 4 are made virtually equal to one another with respect to the paths respectively passing through the regions 3a to 3g of the phosphor layer 3, divided by the insulators 25. That is, in the linear light-emitting device 20, as the distance to the terminal formed on the transparent electrode 2 becomes shorter, in other words, as the length of the passage through the transparent electrode 2 becomes shorter, the intervals between the insulators 25 are made narrower so that the electric resistance in the phosphor layer 3 is made higher. In contrast, as the distance to the terminal formed on the transparent electrode 2 becomes longer, in other words, as the length of the passage through the transparent electrode 2 becomes longer, the intervals between the insulators 25 are made wider so that the electric resistance in the phosphor layer 3 is made lower. Here, at a position close to the connection terminal side, the electric resistance of the transparent electrode 2 is low because of the short passage length in the transparent electrode 2, while, at a position far from the connection terminal side, the electric resistance of the transparent electrode 2 is high because of the long passage length in the transparent electrode 2. Therefore, the intervals of the insulators 25 are determined so that the total value of electric resistance values determined by the intervals between the insulators 25 and the passage lengths in the transparent conductive film 2 are made virtually equal to one another, with respect to the paths respectively passing through the divided regions 3a to 3g of the phosphor layer 3.

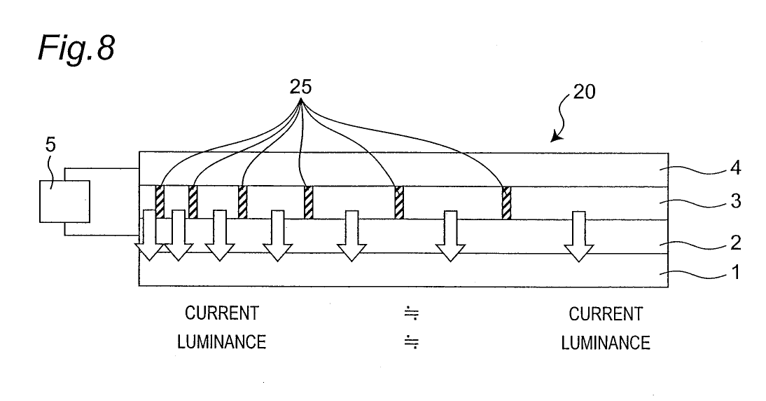

In FIG. 7, the phosphor layer 3 is divided into the regions 3a to 3g as described above, and the quantities of electric currents flowing through the respective regions are made virtually equal to one another as shown in a schematic diagram of FIG. 8. In this manner, since the electric currents flowing through the phosphor layer 3 at the respective positions of 3a to 3g of the linear light-emitting device 20 are made virtually equal to one another, light emission luminances of 12a to 12g can be made uniform. Thus, the uniformity of luminance in the linear light-emitting device 20 can be improved.

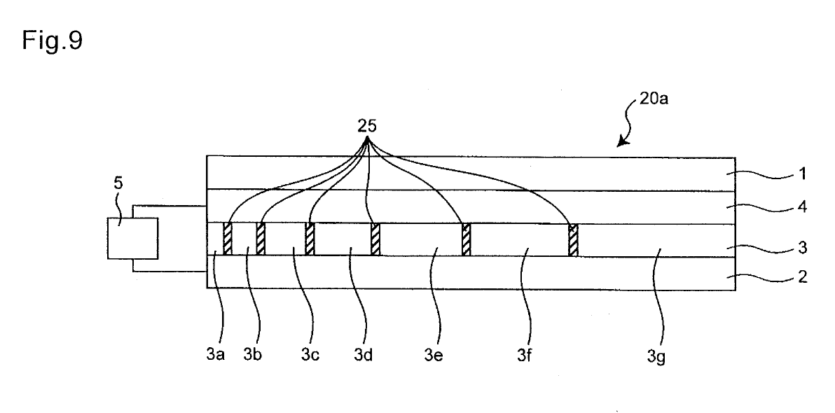

Here, in the linear light-emitting device 20 of FIG. 7, the substrate 1 is disposed on the transparent electrode 2 side; however, for example, as shown by a linear light-emitting device 20a of FIG. 9, the substrate 1 may be disposed on the metal electrode 4 side. In this case, it is not necessary for the substrate 1 to have a light-transmitting property, and in addition to the aforementioned materials used for the substrate 1, a Si substrate, a ceramics substrate, a metal substrate or the like may be used as well. Moreover, in the case where the substrate 1 has a conductive property, that is, in the case of a metal substrate, for example, made from Al or the like, the substrate 1 and the metal electrode 4 may be integrally formed. Moreover, the position of the terminal to which the power supply 5 is connected in the metal electrode 4 may be set on a shorter side, that is, an opposing side in the longitudinal direction.

Moreover, the present second embodiment is characterized by the fact that the phosphor layer 3 is electrically divided into a plurality of regions 3a to 3g by the insulators 25, and the material properties, the structures and the materials, shown here, are examples, and the present invention is not intended to be limited thereby.

Moreover, in the same manner as in first embodiment, another feature of the linear light-emitting device 20 is that the phosphor layer 3 has a polycrystalline structure made from an n-type semiconductor substance 21, with a p-type semiconductor substance 23 being segregated to a grain boundary 22 of this polycrystalline structure.

### Third Embodiment

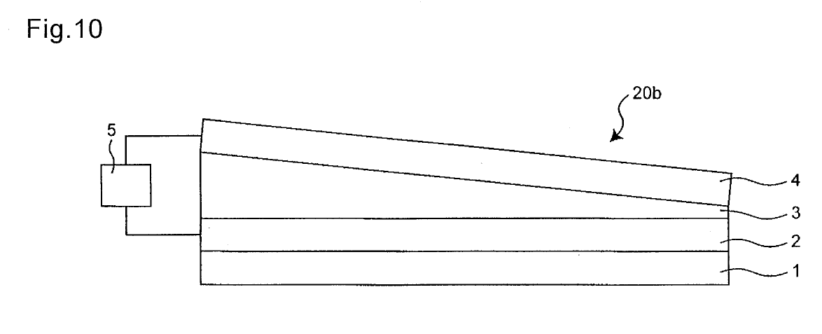

FIG. 10 is a cross-sectional view that schematically shows a linear light-emitting device 20b in accordance with third embodiment. This linear light-emitting device 20b is different from the linear light-emitting device relating to embodiments 1 and 2 in that the film thickness of the phosphor layer 3 is varied in the longitudinal direction. In other words, in this linear light-emitting device 20b, by continuously changing the film thickness of the phosphor layer 3 in the longitudinal direction in such a manner as to be indicated by a linear function, the electric resistance values of the respective paths that extend from the terminals formed on the transparent electrode 2 to reach terminals attached to the metal electrode 4, through the transparent electrode 2, the respective portions of the phosphor layer 3 and the metal electrode 4, can be made virtually equal to one another. This structure is realized by making the film thickness of the phosphor layer 3 thicker as the distance from the terminal of the transparent electrode 2 in the longitudinal direction becomes closer, so that the electric resistance of the phosphor layer 3 is made higher. In contrast, the film thickness of the phosphor layer 3 is made thinner, as the distance from the terminal thereof becomes farther, so that the electric resistance of the phosphor layer 3 is made lower. With this arrangement, the uniformity of luminance in the longitudinal direction can be improved in the linear light-emitting device 20b.

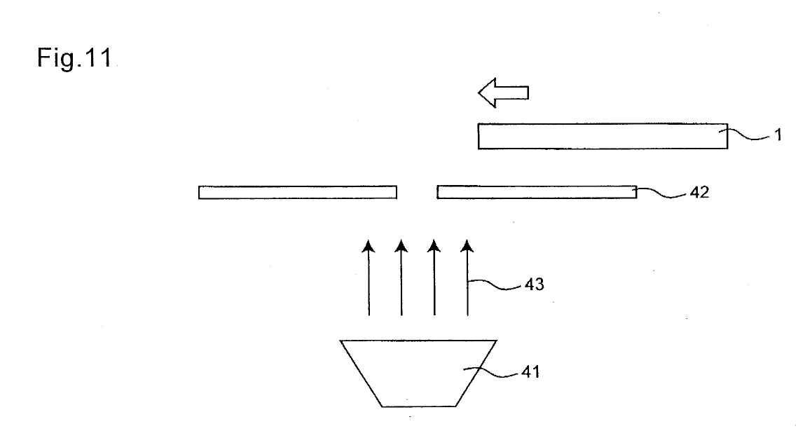

FIG. 11 is a schematic view that shows a structure of a device for manufacturing the linear light-emitting device 20b of third embodiment. This manufacturing device for the linear light-emitting device 20b is provided with a vapor deposition source 41, a mask 42 having a slit that partially allows vapor 43 from the vapor deposition source 41, used for forming a phosphor layer, to pass therethrough, and a substrate moving device that moves a substrate 1 on the side opposing to the vapor deposition source 41 relative to the mask 42, with its velocity being changed. The vapor deposition source 41 is made from a material used for forming the phosphor layer 3. By heating the vapor deposition source 41 by using an EB method, a resistor heating method or the like, the vapor 43 is evaporated toward the mask 42 side. The mask 42 has an opening on the slit. On the upper portion of the mask 42, the substrate 1 with electrodes is allowed to move in a direction indicated by an arrow by the substrate moving device so that the phosphor layer 3 is formed only on the portion of the substrate 1 that is allowed to pass through the opening on the slit of the mask 42. For this reason, by changing the moving speed of the substrate 1, the film thickness of the phosphor layer 3 can be changed in the longitudinal direction.

### <Concerning Film-Thickness Control of Phosphor Layer>

A method for forming the phosphor layer 3 of the linear light-emitting device 20b will be described, with reference to FIG. 11. A sputtering method and a vapor deposition method may be used as the method for forming the phosphor layer 3. As described above, the film thickness of the phosphor layer 3 can be continuously changed in the longitudinal direction by changing the moving speed of the substrate 1. The amount of change in the film thickness in the longitudinal direction of the phosphor layer 3 is varied depending on the distance of the transparent electrode 2 from the connection terminal. In other words, the amount of change is desirably set so that the electric resistance values of the respective paths that extend from the connection terminals of the transparent electrode 2 to reach the metal electrode 4, after passing through the transparent electrode 2 and the phosphor layer 3, can be made virtually equal to one another. More specifically, the film thickness of the phosphor layer 3 on the connection terminal side of the transparent electrode 2 is made thicker, while the film thickness of the phosphor layer 3 on the side opposing the connection terminal is made thinner. With this arrangement, in the respective paths of the linear light-emitting device 20b, the electric currents flowing through the phosphor layer 3 can be made equal to one another so that the uniformity of the light emission luminance of the linear light-emitting device 20b can be improved.

Here, in the present third embodiment also, the substrate may be placed on the metal electrode 4 side in the same manner as in first embodiment.

### Fourth Embodiment

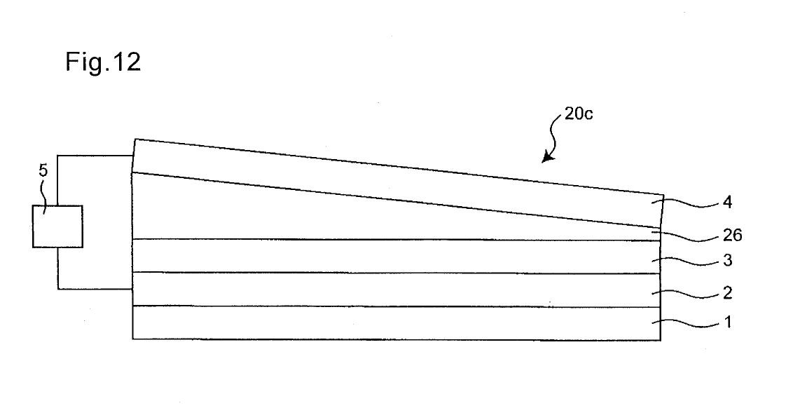

FIG. 12 is a cross-sectional view that schematically shows a linear light-emitting device 20c in accordance with fourth embodiment. This linear light-emitting device 20c in accordance with fourth embodiment of the present invention is characterized in that an electric resistance adjusting layer 26 is formed between the phosphor layer 3 and the metal electrode 4. This electric resistance adjusting layer 26 is designed so that its resistance value in the thickness direction is made smaller as the distance from the terminal formed on the transparent electrode 2 in the longitudinal direction is made longer. More specifically, the film thickness of the electric resistance adjusting layer 26 is continuously made smaller in such a manner as to be indicated by a linear function, as the distance from the terminal formed on the transparent electrode 2 in the longitudinal direction is made longer. By using the electric resistance adjusting layer 26, the current density of the phosphor layer 3 is made constant in the longitudinal direction so that the luminance can be made uniform in the longitudinal direction. In other words, by forming the electric resistance adjusting layer 26, the electric resistance values of the respective paths that extend from the terminals formed on the transparent electrode 2 to reach terminals attached to the metal electrode 4, through the transparent electrode 2, the phosphor layer 3 and the metal electrode 4, can be made virtually equal to one another, independent of the length from the terminal attached to the end portion of the transparent electrode 2 in the longitudinal direction. In the electric resistance adjusting layer 26, the specific resistance value of its material needs to be made higher than that of the metal electrode 4, and is preferably set closer to the specific resistance value of the phosphor layer material or the transparent electrode material.

In the linear light-emitting device 20c of the present fourth embodiment, the resistance value in the thickness direction is changed by continuously changing the film thickness of the electric resistance adjusting layer 26 in the longitudinal direction; however, the materials, the structures and the forming methods of the respective components, shown here, are examples, and the present invention is not intended to be limited thereby.

### Fifth Embodiment

### <Schematic Structure of Linear Light-Emitting Device>

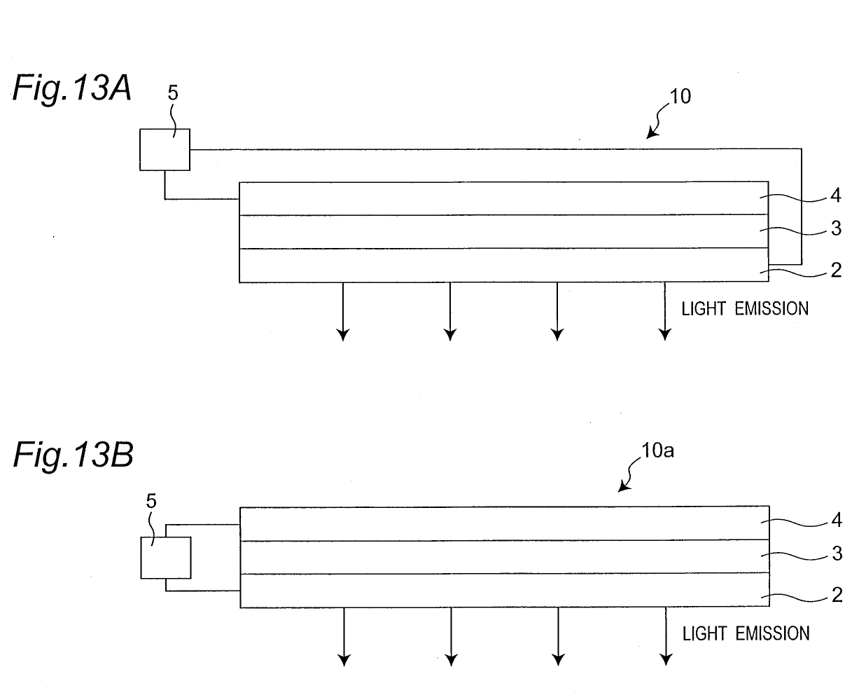

FIG. 13A is a cross-sectional view that shows a schematic structure of a linear light-emitting device 10 in accordance with fifth embodiment of the present invention. FIG. 13B is a cross-sectional view that shows a linear light-emitting device 10a of another example. This linear light-emitting device 10 is provided with a linear phosphor layer 3, and paired transparent electrode 2 and back electrode (metal electrode) 4 that are formed in a manner so as to sandwich the phosphor layer 3 in the longitudinal direction. The transparent electrode 2 and the back electrode (metal electrode) 4 are electrically connected to each other with power supply 5 interposed therebetween. In this case, the transparent electrode 2 connected to the negative electrode side functions as an electron injecting electrode (second electrode), and the back electrode (metal electrode) 4 connected to the positive electrode side functions as a hole injecting electrode (first electrode). Here, in the linear light-emitting device 10 shown in FIG. 13A, terminals that respectively connect the electrodes 2 and 4 with the power supply are formed on respectively different short sides, while in the linear light-emitting device 10a shown in FIG. 13B, the terminals that respectively connect the electrodes 2 and 4 with the power supply are formed on the same short side, which makes the two devices different from each other.

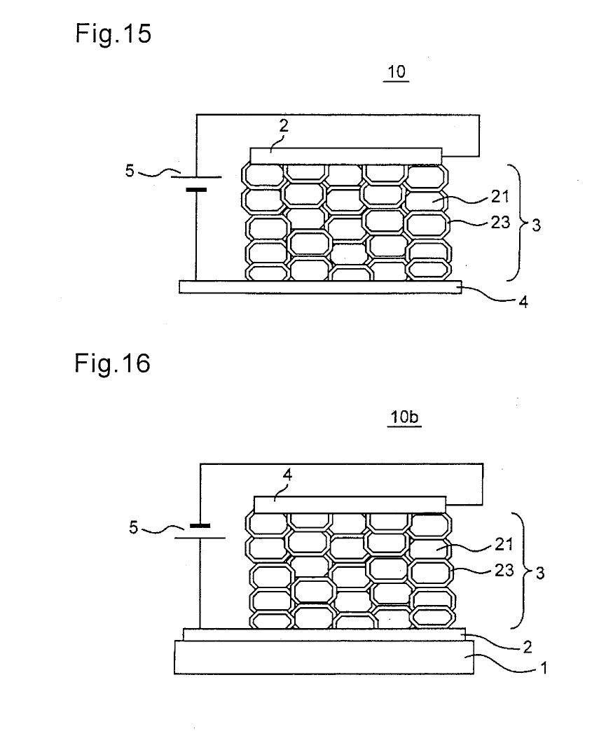

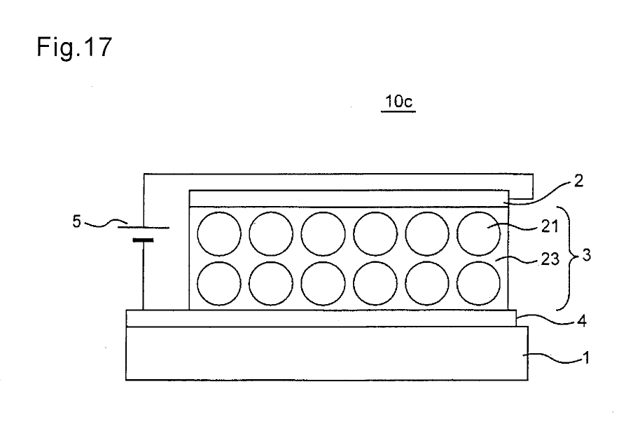

In this linear light-emitting device 10, as shown in FIG. 15, the phosphor layer 3 is constructed as an integrated unit of n-type semiconductor particles 21, and characterized in that a p-type semiconductor substance 23 is segregated between the particles. Here, as shown in FIG. 15, the phosphor layer 3 is sandwiched by the paired electrodes 2 and 4 without using a substrate; however, not limited to this structure, as shown by the linear light-emitting device 10b of another example shown in FIG. 16, a transparent electrode 2 is formed on a substrate 1, and the phosphor layer 3 and the back electrode 4 may be successively laminated thereon. Alternatively, as shown by a linear light-emitting device 10c of still another example shown in FIG. 17, the phosphor layer 3 is characterized by a structure in which the n-type semiconductor particles 21 are dispersed in a medium made from the p-type semiconductor 23. In this manner, by forming many interfaces between the n-type semiconductor particles and the p-type semiconductor, the hole injecting property is improved so that the recombination type light emission between electrons and holes is effectively generated; thus, a linear light-emitting device capable of emitting light with high luminance at a low voltage can be achieved. Moreover, by providing a structure in which n-type semiconductor particles are electrically connected to the electrode through a p-type semiconductor, the light-emitting efficiency can be improved so that it becomes possible to provide a linear light-emitting device that can emit light at a low voltage, with high luminance.

Moreover, in the linear light-emitting device 10, the transparent electrode 2 and the back electrode 4 are electrically connected to each other with a DC power supply 5 interposed therebetween. When power is supplied from the DC power supply 5, a potential difference is generated between the transparent electrode 2 and the back electrode 4 so that a voltage is applied to the phosphor layer 3. Thus, the phosphor layer 3, placed between the transparent electrode 2 and the back electrode 4, is allowed to emit light, and the resulting light transmits through the transparent electrode 2, and is extracted from the linear light-emitting device 10.

Here, not limited to the above-mentioned structure, various modifications may be made therein on demand: for example, a plurality of thin dielectric layers may be formed between the electrode and the phosphor layer so as to regulate an electric current; a driving process is carried out by an AC power supply; the back electrode is made transparent; the back electrode is prepared as a black electrode; a structure to seal the entire or a part of the linear light-emitting device 10 is further provided; and a structure for color-converting the light-emission color of the phosphor layer 3 is further provided the front side in a light emission taking-out direction. For example, a white-color linear light-emitting device may be prepared by combining a blue-color phosphor layer and a color-conversion layer that converts a blue color into a green color and a red color, with each other.

Here, with respect to the respective component members of the linear light-emitting device relating to fifth embodiment of the present invention, except for those members the features of which are explained, virtually the same members as those of the respective component members of the linear light-emitting device relating to first embodiment may be used.

Moreover, although FIG. 15 shows a structure in which the phosphor layer 3 is sandwiched by the paired electrodes 2 and 4 without using a substrate, a substrate 1 for supporting the entire structure may be installed as shown by the linear light-emitting device 10b of another example shown in FIG. 16. For example, a transparent electrode 2 is formed on a substrate 1, and the phosphor layer 3 and the back electrode 4 may be successively laminated thereon.

### <Phosphor Layer>

The phosphor layer 3, which is sandwiched between the transparent electrode 2 and the back electrode 4, has either one of the following two structures.

(i) A structure (see FIG. 15) corresponding to an aggregated body of n-type semiconductor particles, in which a p-type semiconductor 23 is segregated between the particles. Here, the aggregated body of the n-type semiconductor particles 21 itself forms a layer.
(ii) A structure (see FIG. 17) in which n-type semiconductor particles 21 are dispersed in a medium of a p-type semiconductor 23.

Here, the respective n-type semiconductor particles 21 forming the phosphor layer 3 are preferably electrically joined to the electrodes 2 and 4 through the p-type semiconductor 23.

### <Illuminant>

The material for n-type semiconductor particles 21 is an n-type semiconductor material having a majority of carriers as electrons that exhibits an n-type conductive property. The material may be a compound semiconductor consisting of Group 12 and Group 16. Moreover, the material may be a compound semiconductor consisting of Group 13 and Group 15. More specifically, the material has an optical band gap size in a range of visible light rays, and examples thereof include: ZnS, ZnSe, GaN, InGaN, AlN, GaAlN, GaP, CdSe, CdTe, SrS and CaS, serving as host crystals, and these may be used as host crystals, or may include as additives, one or a plurality of kinds of atoms or ions, selected from the group consisting of Cu, Ag, Au, Ir, Al, Ga, In, Mn, Cl, Br, I, Li, Ce, Pr, Nd, Pm, Sm, Eu, Gd, Tb, Dy, Ho, Er, Tm and Yb. The light emission color from the phosphor layer 3 is also determined by the kinds of these elements.

In contrast, the material for the p-type semiconductor 23 is a p-type semiconductor material having a majority of carriers as holes that exhibits a p-type conductive property. Examples of this p-type semiconductor material include compounds, such as Cu₂S, ZnS, ZnSe, ZnSSe, ZnSeTe and ZnTe, and nitrides, such as GaN and InGaN. Among these p-type semiconductor materials, Cu₂S and the like inherently exhibit a p-type conductive property; however, with respect to the other materials, one or more kinds of elements, selected from the group consisting of nitrogen, Ag, Cu and In, are added thereto as additives and used. Moreover, a chalcopyrite type compound, such as CuGaS₂ and CuAIS₂, that exerts a p-type conductive property may be used.

The linear light-emitting device 10 of the present embodiment is characterized in that the phosphor layer 3 is provided with: either one of (i) a structure in which the p-type semiconductor 23 is segregated between the particles of the n-type semiconductor particles 21 (FIG. 15) and (ii) a structure in which the n-type semiconductor particles 21 are dispersed in a medium of the p-type semiconductor 23 (FIG. 17). As the conventional example shown in FIG. 15, in the case where the medium that is electrically joined to semiconductor particles 61 is indium tin oxide 63, electrons that reach the semiconductor particles 61 are allowed to emit light; however, since the hole concentration of indium tin oxide is small, holes to be recombined become insufficient. Therefore, the light emission with high luminance by the recombination between electrons and holes is not expected. In order to obtain continuous light emission having, in particular, high luminance and high efficiency, the present inventor tries to provide a structure by which, in the phosphor layer 3, holes can be efficiently injected together with the injection of electrons. In order to realize the structure, it is necessary to allow many holes to reach the inside of each illuminant particle or the interface of the particles, and it is also necessary to quickly carry out the injection of holes from the electrode opposing the injection electrode for electrons, with the holes being allowed to reach the illuminant particles or the interface thereof. After extensive studies, the present inventor has found that, by using either one of the above-mentioned structures (i) and (ii) as the structure of the phosphor layer 3, electrons can be efficiently injected to the inside of each of n-type semiconductor particles or the interface thereof, with holes being also efficiently injected thereto. In other words, in accordance with the phosphor layer 3 having each of the above-mentioned structures, electrons, injected from the electrode, are allowed to reach the n-type semiconductor particles 21 through the p-type semiconductor 23, while many holes are allowed to reach the illuminant particles from the other electrode so that light is efficiently emitted by the recombination of the electrons and the holes. With this structure, it becomes possible to realize a linear light-emitting device that can emit light with high luminance at a low voltage, and consequently to achieve the present invention. Moreover, by introducing a donor or an acceptor, light emissions, derived from the recombination of free electrons and holes captured by the acceptor, the recombination of free holes and electrons captured by the donor, and the paired donor and acceptor, can also be obtained. Moreover, a light emission derived from an energy shift caused by the presence of other adjacent ionic species can be obtained.

In the case where a zinc-based material, such as ZnS, is used as the n-type semiconductor particles 21 of the phosphor layer 3, an electrode made of a metal oxide containing zinc, such as ZnO, AZO (made by doping zinc oxide, for example, with aluminum) and GZO (made by doping zinc oxide, for example, with gallium), is preferably used as, at least, either one of the transparent electrode 2 and the back electrode 4. The present inventor has found that, by using a combination of specific n-type semiconductor particles 21 and a specific transparent electrode 2 (or a back electrode 4), light emission with high efficiency is obtained.

In other words, considering of the work function of the transparent electrode 2 (or the back electrode 4), shows that the work function of ZnO is 5.8 eV, while the work function of ITO (indium tin oxide) conventionally used as a transparent electrode is 7.0 eV. Here, since the work function of the zinc-based material used as the n-type semiconductor particles 21 of the phosphor layer 3 is 5 to 6 eV, the work function of ZnO, which is closer to the work function of a zinc-based material in comparison with that of ITO, provides an advantage that the electron injecting property to the phosphor layer 3 is improved. This advantage is also obtained when a zinc-based material, such as AZO and GZO, is used as the transparent electrode 2 (or the back electrode 4).

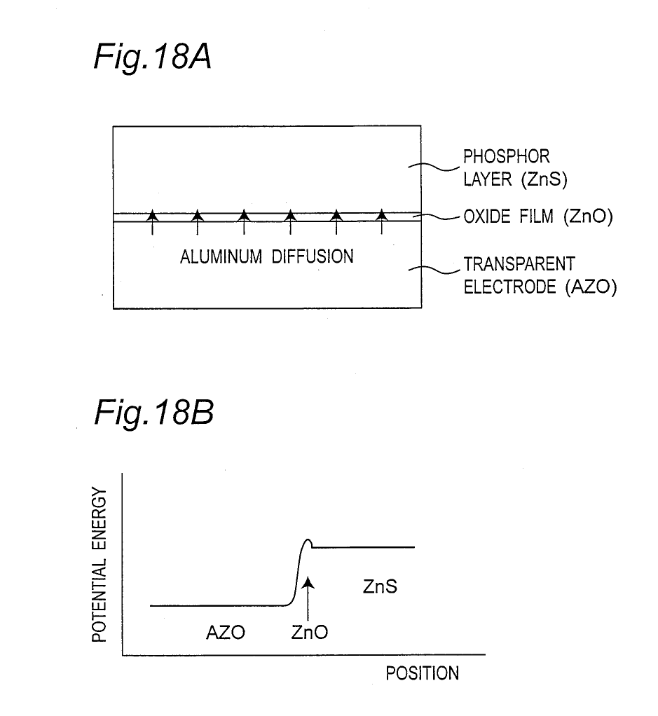

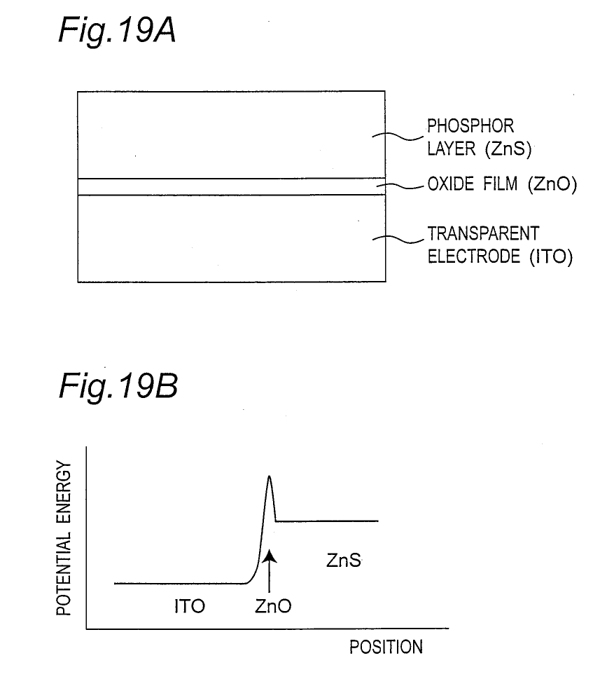

FIG. 18A is a schematic diagram that shows the vicinity of an interface between the phosphor layer 3 made from ZnS and the transparent electrode 2 (or the back electrode 4) made from AZO. FIG. 18B is a schematic diagram that explains a displacement of potential energy of FIG. 18A. FIG. 19A, which shows a comparative example, is a schematic diagram that shows an interface between a light-emitting electrode 3 made from ZnS and a transparent electrode made from ITO, and FIG. 19B is a schematic diagram that explains a displacement of potential energy of FIG. 19A.

As shown in FIG. 18A, in the above-mentioned preferred example, since the n-type semiconductor particles 21 forming the phosphor layer 3 is made from a zinc-based material (ZnS), with the transparent electrode 2 (or the back electrode 4) being made from a zinc oxide-based material (AZO), an oxide to be formed on the interface between the transparent electrode 2 (or the back electrode 4) and the phosphor layer 3 is zinc oxide (ZnO). Moreover, on the interface, a doping material (Al) is diffused upon forming a film, with the result that an oxide film having low resistance is formed thereon. Moreover, the above-mentioned zinc oxide-based (AZO) transparent electrode 2 (or the back electrode 4) has a crystal structure of a hexagonal system, and since the zinc-based material (ZnS) corresponding to the n-type semiconductor substance 21 forming the phosphor layer 3 also forms a hexagonal crystal, or has a crystal structure of a cubic system, little strain is caused on the interface between the two substances, resulting in a small energy barrier. Consequently, as shown in FIG. 18B, the displacement in potential energy is kept in a low level.

In contrast, in the comparative example, the transparent electrode is made from ITO that is not a zinc-based material, as shown in FIG. 19A; therefore, since the oxide film (ZnO) formed on the interface has a crystal structure different from that of ITO, the energy barrier on the interface becomes greater. Therefore, as shown in FIG. 19B, the displacement in potential energy becomes greater on the interface to cause a reduction in the light-emitting efficiency of the light-emitting element.

As described above, in the case where a zinc-based material, such as ZnS and ZnSe, is used as the n-type semiconductor particles 21 of the phosphor layer 3, by combining it with the transparent electrode 2 (or the back electrode 4) made from a zinc oxide-based material, it becomes possible to provide a linear light-emitting device with superior light-emitting efficiency.

In the above-mentioned example, an explanation has been given by exemplifying AZO doped with aluminum and GZO doped with gallium as the material for the transparent electrode 2 (or the back electrode 4) containing zinc; however, the same effects can be obtained even when zinc oxide, doped with at least one kind of material selected from the group consisting of aluminum, gallium, titanium, niobium, tantalum, tungsten, copper, silver and boron, is used.

### <Manufacturing Method>

One example of a method for manufacturing the linear light-emitting device 10, in accordance with fifth embodiment, will be described. In this manufacturing method, an explanation is given to the structure using a substrate 1. Here, the same manufacturing method may be applicable to a phosphor layer made from another material as described above.

(a) First, Corning 1737 is prepared as the substrate 1.
(b) A linear back electrode 4 is formed on the substrate 1. For example, Al is used, and the film thickness is set to 200 nm.
(c) A linear phosphor layer 3 is formed on the back electrode 4. Powdered ZnS and Cu₂S are respectively charged into a plurality of evaporating sources, and each of the material is irradiated with an electron beam under vacuum under vacuum (about 10⁻⁶ Torr) so as to be film-formed on the substrate 1 as the phosphor layer 3. At this time, the substrate temperature is set to 200° C. so that ZnS and Cu₂S are vapor deposited together.
(d) After forming the film, this is subjected to an annealing at 700° C. for about one hour in a sulfur atmosphere. By examining this film by using the X-ray diffraction and the SEM, the polycrystalline structure with minute ZnS crystal grains and the segregated portion of CuₓS can be observed. Although the reason for this has not been clarified, it is considered that a phase separation occurs between ZnS and CuₓS, with the result that the above-mentioned segregated structure is formed.
(e) Successively, a linear transparent electrode 2 is formed by using, for example, ITO. The film thickness is set to 200 nm.
(f) Next, a transparent insulator layer made from, for example, silicon nitride or the like is formed on the phosphor layer 3 and the transparent electrode 2 as a protective layer (not shown in the figure).

By using the above-mentioned processes, a linear light-emitting device 10 of fifth embodiment is obtained.

In the linear light-emitting device 10 of fifth embodiment, the transparent electrode 2 and the back electrode 4 were connected to a power supply 5, with a DC voltage being applied therebetween, so that light emission evaluations were carried out, and as a result, light emission was initiated at an applied voltage of 15 V, and a light emission luminance of about 600 cd/m² was exerted at 35 V.

### <Plane Light Source>

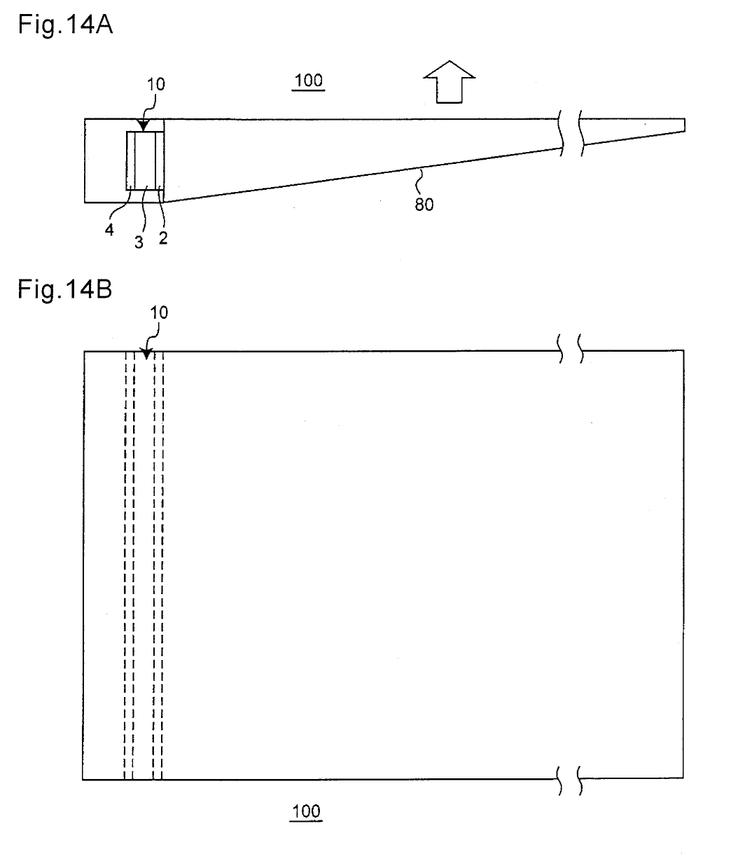

FIG. 14A is a front elevational view showing a structure of a plane light source 100 in which the linear light-emitting device 10 in accordance with fifth embodiment of the present invention is used, and FIG. 14B is a plan view thereof. This plane light source 100 is provided with the linear light-emitting device 10 of fifth embodiment and a light-guide plate 80 that reflects linear light outputted from the linear light-emitting device 10 so as to be formed into planar light. In this plane light source 100, linear light outputted from the linear light-emitting device 10 is reflected by a face of the light-guide plate 80 of FIG. 14A on the lower side on the drawing face, and is taken out from a face on the upper side on the drawing face as the planar light. The linear light-emitting device 10 is disposed with its longitudinal direction being made in parallel with the light-emitting face of the plane light source 100 from which the planar light is taken out. Moreover, the output direction of linear light of the linear light-emitting device 10 is made in parallel with the light-emitting face of the plane light source 100 from which the planar light is taken out. The light-guide plate 80 is disposed in a slightly tilted manner so as to make an acute angle with the light-emitting face of the plane light source 100 from which the planar light is taken out.

In accordance with this plane light source 100, since the linear light-emitting device 10 relating to fifth embodiment is used, and since the device is arranged in combination with the light-guide plate 80 that changes the linear light outputted from the linear light-emitting device 10 into the planar light, a thinner apparatus can be achieved at a low cost.

Here, the linear light-emitting device using the above-mentioned inorganic EL light-emitting element causes a reduction in electric resistance of the phosphor layer. For this reason, in the case where the phosphor layer, as it is, is used with a large surface area, as a plane light source for a backlight for use in, for example, a liquid crystal display or the like, too much current tends to flow, making it difficult to use this as the plane light source. Therefore, in the case where the linear light-emitting device is used as a backlight or the like, a linear light-source type use in combination with a light-guide plate as described above, or a dot light-source type use like an LED, is preferably adopted, in the same manner as in a cold cathode tube.

### Sixth Embodiment

### <Schematic Structure of Linear Light-Emitting Device>

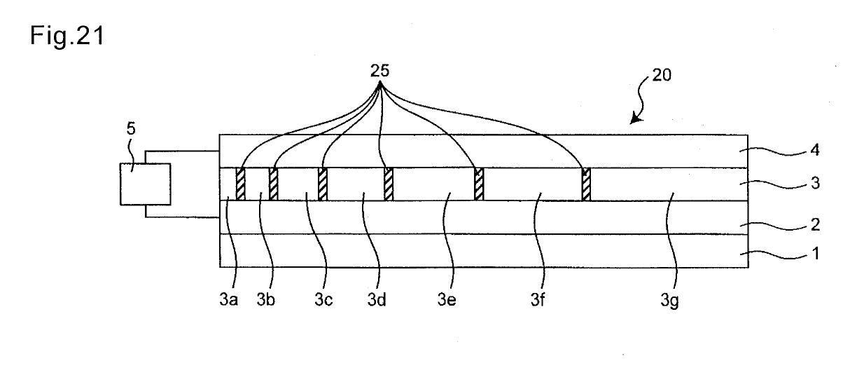

FIG. 21 is a cross-sectional view that shows a linear light-emitting device 20 in accordance with sixth embodiment of the present invention, viewed in a direction perpendicular to the light-emitting face with respect to the longitudinal direction thereof. This linear light-emitting device 20 functions as a linear light source. This linear light-emitting device 20 is configured by a substrate 1, a transparent electrode 2, a phosphor layer 3 and a metal electrode 4, and the phosphor layer 3 is characterized by being electrically divided into regions 3a to 3g in the longitudinal direction by a plurality of insulators 25. Moreover, in this linear light-emitting device 20, a voltage is applied between the transparent electrode 2 and the metal electrode 4 by a power supply 5 so that the phosphor layer 3 is allowed to emit light, and the light is taken out from the substrate 1 side. In this linear light-emitting device 20, by electrically dividing the phosphor layer 3 into a plurality of regions along the longitudinal direction, a plurality of electrical paths that extend from the transparent electrode 2 to reach the metal electrode 4 through the respective regions 3a to 3g divided in the phosphor layer 3 are allowed to have virtually the same electric resistance value so that it becomes possible to provide uniform luminance in the longitudinal direction.

### <Featured Portion of Linear Light-Emitting Device of the Present Sixth Embodiment>

The linear light-emitting device 20 in accordance with sixth embodiment of the present invention has a featured portion in structure in which the phosphor layer 3 is electrically divided into respective regions 3a to 3g along the longitudinal direction by a plurality of insulators 25. By finding out the following problems with the linear light-emitting device relating to fifth embodiment, the present inventor has reached the above-mentioned new feature so as to solve the problems.

The following description will explain the problems with the linear light-emitting device relating to first embodiment, found by the present inventor, and then explain how the problems can be solved by the feature of the present invention.

<Problems with Linear Light-Emitting Device Relating to Fifth Embodiment>

First, the present inventor has found a problem of luminance non-uniformity in the case where a linear light-emitting device of fifth embodiment is used as a linear light source. In other words, since the electric resistance of the phosphor layer 3 is low, a comparatively large electric current flows upon light emission, and this causes a voltage drop in the transparent electrode 2 having a comparatively high resistance value, with the result that the current value of each of paths that pass through the respective portions of the phosphor layer 3 becomes gradually smaller from a terminal corresponding to a contact point from a power supply in the longitudinal direction of the transparent electrode 2 to cause a problem of non-uniformity in luminance.

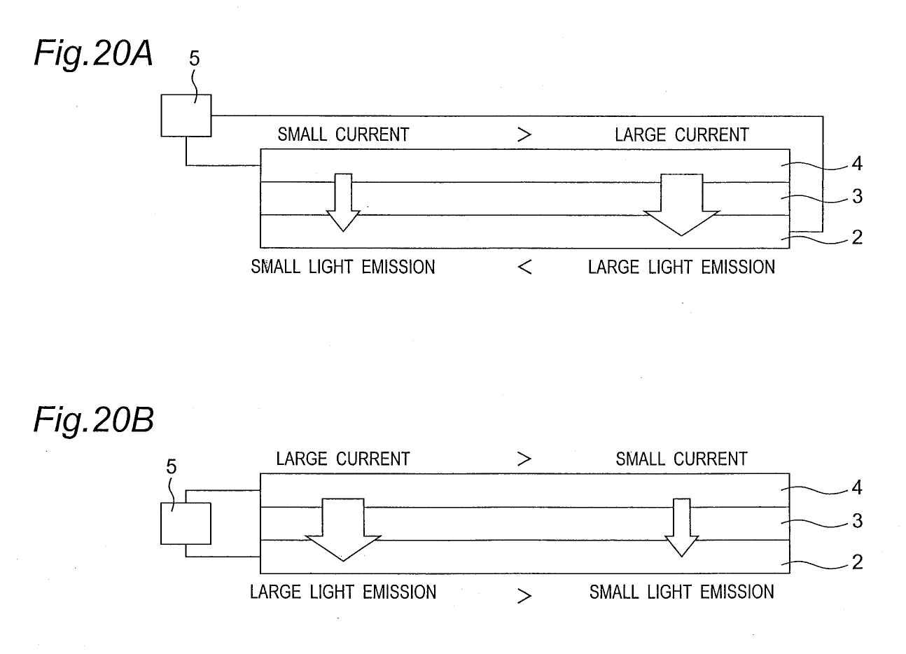

Referring to FIGS. 20A and 20B, the above-mentioned problem is further explained. FIGS. 20A and 20B are schematic cross-sectional views that briefly show the structure of a linear light-emitting device (from which substrates and the like are omitted). In the linear light-emitting device of FIG. 20A, respective terminals from a power supply 5 to two electrodes 2 and 4 are wired to respectively different shorter sides of the two ends in the longitudinal direction; in contrast, in the linear light-emitting device of FIG. 20B, respective terminals to the two electrodes 2 and 4 are wired to the same shorter side. The linear light-emitting devices are allowed to emit light when power is supplied to the respective electrodes 2 and 4 from the power supply 5 through the respective terminals. Here, the flow of an electric current in the linear light-emitting device will be described. First, with respect to the resistance values of the respective electrodes 2 and 4, the specific resistance value of a material forming the metal electrode 4 is extremely lower than the specific resistance values of a material forming the transparent electrode 2. Next, with respect to the resistance value of the phosphor layer 3, the distance between the transparent electrode 2 and the metal electrode 4 in a direction in which the current flows is sufficiently thin because of the thin-film phosphor layer 3, and since the specific resistance value of a material forming the phosphor layer is low in comparison with that of a material forming a conventional phosphor layer, the inside of the phosphor layer 3 has a low resistance value. Moreover, since the thickness of the phosphor layer 3 is virtually uniform in the longitudinal direction, the resistance value inside the phosphor layer 3 is kept virtually uniform in the longitudinal direction. Consequently, in the linear light-emitting device, the specific resistance value of the transparent electrode 2 gives greater influences to the distribution of an electric current flowing through the phosphor layer. That is, more electric current flows where there is less resistance; therefore, as the distance in the transparent electrode 2 through which the electric current flows becomes shorter, more electric current is allowed to flow. Here, in the phosphor layer 3, as the electric current becomes higher, the light-emission luminance becomes higher. In other words, as the distance from the terminal corresponding to a contact point from the power supply 5 in the longitudinal direction of the transparent electrode 2 becomes longer, the electric current value flowing through the phosphor layer 3 becomes gradually smaller to cause the light-emission luminance of the phosphor layer 3 becomes gradually smaller. In particular, in the phosphor layer 3 of the present embodiment made from a material having a lower resistance value in comparison with that of the material forming a conventional phosphor layer, the value of the electric current flowing at the time of light emission becomes greater, and the influences of a voltage drop in the transparent electrode 2 also become greater. Moreover, the difference between the quantity of the electric current and the quantity of light emission becomes greater between the side of the transparent electrode 2 closer to the terminal corresponding to the contact point from the power supply and the side thereof farther from the terminal in the longitudinal direction. Therefore, in the linear light-emitting device of FIG. 20A, the luminance on the right side in the longitudinal direction becomes higher than that on the left side, while, in the linear light-emitting device of FIG. 20B, the luminance on the left side in the longitudinal direction becomes higher than that on the right side. Here, arrows shown in FIG. 20 are given by imaging the quantity of electric current, and do not represent the direction or quantity of the electric current.

The featured point of the linear light-emitting device 20 relating to the present sixth embodiment has been devised so as to solve the problem that, when a linear light-emitting device is used as a linear light source, the uniformity in luminance in the longitudinal direction is lowered. In other words, in the present invention, in a plurality of paths that extend through the phosphor layer 3 between the paired electrodes 2 and 4 of the linear light-emitting device, by changing the inner resistance values of the respective paths depending on respective portions thereof, it becomes possible to solve the problem with the uniformity in luminance.

The structure of the phosphor layer 3 in this linear light-emitting device 20 will be described. This phosphor layer 3 is electrically divided into a plurality of regions 3a to 3g by a plurality of insulators 25. First, the insulators 25 will be explained, and next, the layout of the insulators will be explained.

### <Insulators>

The insulators 25 are formed in the phosphor layer 3, and used for electrically dividing the phosphor layer 3 into the regions 3a to 3g. As the material for the insulators 25, for example, insulating materials, such as, oxide insulators like SiO₂ and Al₂O₃, and plastic resins, may be used, although not particularly limited thereby.

Moreover, the insulators 25 may be formed, for example, by using the following processes.

a) A phosphor layer 3 is formed by using a predetermined method.
b) The phosphor layer 3, thus formed, is subjected to an etching process at its portions where the insulators 25 are to be formed later, by using a photolithography method or the like.
c) In the case where, for example, SiO₂ is embedded into the etched concave portions as the insulators 25, the embedding process is carried out by using a sputtering method, and in the case where a resin is embedded therein as the insulators 25, the embedding process is carried out by using a coating method.
d) Thereafter, the insulators on the upper portion of the phosphor layer 3 are removed by etching or grinding.

The insulators 25 can be disposed inside the phosphor layer 3 by the above-mentioned processes.

Here, not limited to the above-mentioned method, another method may be used in which the insulators 25 are preliminarily formed on the transparent electrode 2, and after patterning the insulators 25 by using a photolithography method or the like, the phosphor layer 3 is formed thereon, and the phosphor layer 3 on the upper portion of the insulators 25 is smoothed by grinding or the like so that regions 3a to 3g, formed by dividing the phosphor layer 3 with the insulators 25, may be obtained.

### <Layout of Insulators>

The layout of the insulators 25 inside the phosphor layer 3 will be described. The intervals of the insulators 25 are determined depending on electric resistance values of the respective paths. The intervals are determined so that the electric resistance values in the paths each of which extends from the power supply 5 through the terminal serving as the contact point to the power supply 5, formed on the transparent electrode 2, and the transparent electrode 2 and the phosphor layer 3 to reach the metal electrode 4 are made virtually equal to one another with respect to the paths respectively passing through the regions 3a to 3g of the phosphor layer 3, divided by the insulators 25. That is, in the linear light-emitting device 20, as the distance to the terminal formed on the transparent electrode 2 becomes shorter, in other words, as the length of the passage through the transparent electrode 2 becomes shorter, the intervals between the insulators 25 are made narrower so that the electric resistance in the phosphor layer 3 is made higher. In contrast, as the distance to the terminal formed on the transparent electrode 2 becomes longer, in other words, as the length of the passage through the transparent electrode 2 becomes longer, the intervals between the insulators 25 are made wider so that the electric resistance in the phosphor layer 3 is made lower. Here, at a position close to the connection terminal side, the electric resistance of the transparent electrode 2 is low because of the short passage length in the transparent electrode 2, while, at a position far from the connection terminal side, the electric resistance of the transparent electrode 2 is high because of the long passage length in the transparent electrode 2. Therefore, the intervals of the insulators 25 are determined so that the total value of electric resistance values determined by the intervals between the insulators 25 and the passage lengths in the transparent conductive film 2 are made virtually equal to one another, with respect to the paths respectively passing through the divided regions 3a to 3g of the phosphor layer 3.

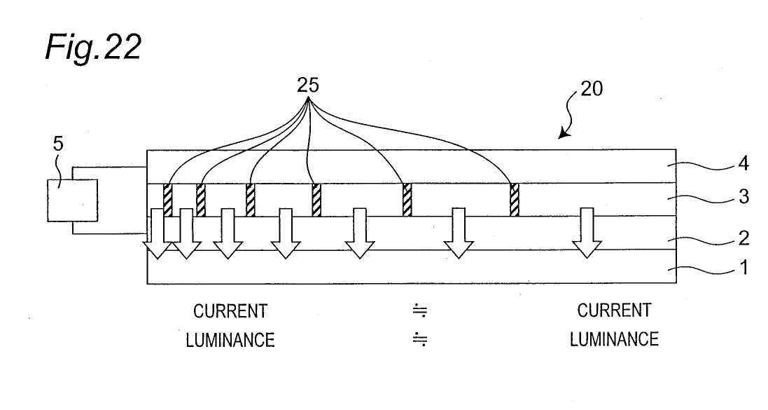

In FIG. 21, the phosphor layer 3 is divided into the regions 3a to 3g as described above, and the quantities of electric currents flowing through the respective regions are made virtually equal to one another as shown in a schematic diagram of FIG. 22. In this manner, since the electric currents flowing through the phosphor layer 3 at the respective positions of 3a to 3g of the linear light-emitting device 20 are made virtually equal to one another, light emission luminances of 12a to 12g can be made uniform. Thus, the uniformity of luminance in the linear light-emitting device 20 can be improved.

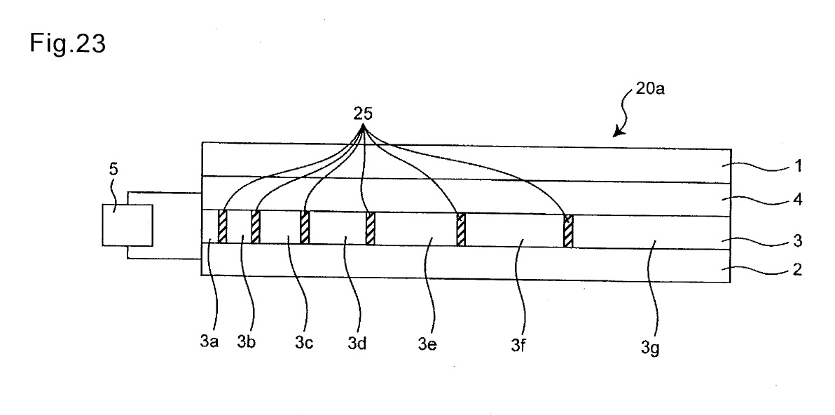

Here, in the linear light-emitting device 20 of FIG. 21, the substrate 1 is disposed on the transparent electrode 2 side; however, for example, as shown by a linear light-emitting device 20a of FIG. 23, the substrate 1 may be disposed on the metal electrode 4 side. In this case, it is not necessary for the substrate 1 to have a light-transmitting property, and in addition to the aforementioned materials used for the substrate 1, a Si substrate, a ceramics substrate, a metal substrate or the like may be used as well. Moreover, in the case where the substrate 1 has a conductive property, that is, in the case of a metal substrate, for example, made from Al or the like, the substrate 1 and the metal electrode 4 may be integrally formed. Moreover, the position of the terminal to which the power supply 5 is connected in the metal electrode 4 may be set on a shorter side, that is, an opposing side in the longitudinal direction.

Moreover, the present sixth embodiment is characterized by the fact that the phosphor layer 3 is electrically divided into a plurality of regions 3a to 3g by the insulators 25, and the material properties, the structures and the materials, shown here, are examples, and the present invention is not intended to be limited thereby.

Moreover, in the same manner as in fifth embodiment, another feature of the linear light-emitting device 20 is that the phosphor layer 3 has either one of (i) a structure in which a p-type semiconductor 23 is segregated between particles of an n-type semiconductor 21 (FIG. 15), and (ii) a structure in which the n-type semiconductor 21 is dispersed in a medium of the p-type semiconductor 23 (FIG. 17).

### Seventh Embodiment

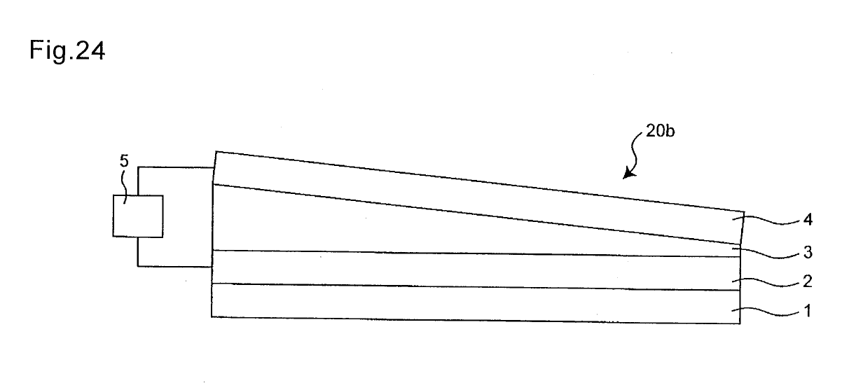

FIG. 24 is a cross-sectional view that schematically shows a linear light-emitting device 20b in accordance with seventh embodiment. This linear light-emitting device 20b is different from the linear light-emitting device relating to embodiments 5 and 6 in that the film thickness of the phosphor layer 3 is varied in the longitudinal direction. In other words, in this linear light-emitting device 20b, by continuously changing the film thickness of the phosphor layer 3 in the longitudinal direction in such a manner as to be indicated by a linear function, the electric resistance values of the respective paths that extend from the terminals formed on the transparent electrode 2 to reach terminals attached to the metal electrode 4, through the transparent electrode 2, the respective portions of the phosphor layer 3 and the metal electrode 4, can be made virtually equal to one another. This structure is realized by making the film thickness of the phosphor layer 3 thicker as the distance from the terminal of the transparent electrode 2 in the longitudinal direction becomes closer, so that the electric resistance of the phosphor layer 3 is made higher. In contrast, the film thickness of the phosphor layer 3 is made thinner, as the distance from the terminal thereof becomes farther, so that the electric resistance of the phosphor layer 3 is made lower. With this arrangement, the uniformity of luminance in the longitudinal direction can be improved in the linear light-emitting device 20b.

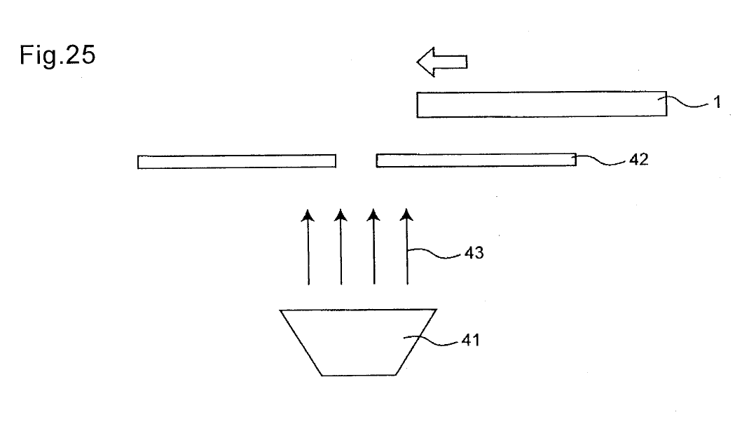

FIG. 25 is a schematic diagram that shows a structure of a device for manufacturing the linear light-emitting device 20b relating to seventh embodiment. This manufacturing device for the linear light-emitting device 20b is provided with a vapor deposition source 41, a mask 42 having a slit that partially allows vapor 43 from the vapor deposition source 41, used for forming a phosphor layer, to pass therethrough, and a substrate moving device that moves a substrate 1 on the side opposing to the vapor deposition source 41 relative to the mask 42, with its velocity being changed. The vapor deposition source 41 is made from a material used for forming the phosphor layer 3. By heating the vapor deposition source 41 by using an EB method, a resistor heating method or the like, the vapor 43 is evaporated toward the mask 42 side. The mask 42 has an opening on the slit. On the upper portion of the mask 42, the substrate 1 with electrodes is allowed to move in a direction indicated by an arrow by the substrate moving device so that the phosphor layer 3 is formed only on the portion of the substrate 1 that is allowed to pass through the opening on the slit of the mask 42. For this reason, by changing the moving speed of the substrate 1, the film thickness of the phosphor layer 3 can be changed in the longitudinal direction.

### <Concerning Film-Thickness Control of Phosphor Layer>

A method for forming the phosphor layer 3 of the linear light-emitting device 20b will be described with reference to FIG. 25. A sputtering method and a vapor deposition method may be used as the method for forming the phosphor layer 3. As described above, the film thickness of the phosphor layer 3 can be continuously changed in the longitudinal direction by changing the moving speed of the substrate 1. The amount of change in the film thickness in the longitudinal direction of the phosphor layer 3 is varied depending on the distance of the transparent electrode 2 from the connection terminal. In other words, the amount of change is desirably set so that the electric resistance values of the respective paths that extend from the connection terminals of the transparent electrode 2 to reach the metal electrode 4, after passing through the transparent electrode 2 and the phosphor layer 3, can be made virtually equal to one another. More specifically, the film thickness of the phosphor layer 3 on the connection terminal side of the transparent electrode 2 is made thicker, while the film thickness of the phosphor layer 3 on the side opposing to the connection terminal is made thinner. With this arrangement, in the respective paths of the linear light-emitting device 20b, the electric currents flowing through the phosphor layer 3 can be made equal to one another so that the uniformity of the light emission luminance of the linear light-emitting device 20b can be improved.

Here, in the present seventh embodiment also, the substrate may be placed on the metal electrode 4 side in the same manner as in first embodiment.

### Eighth Embodiment

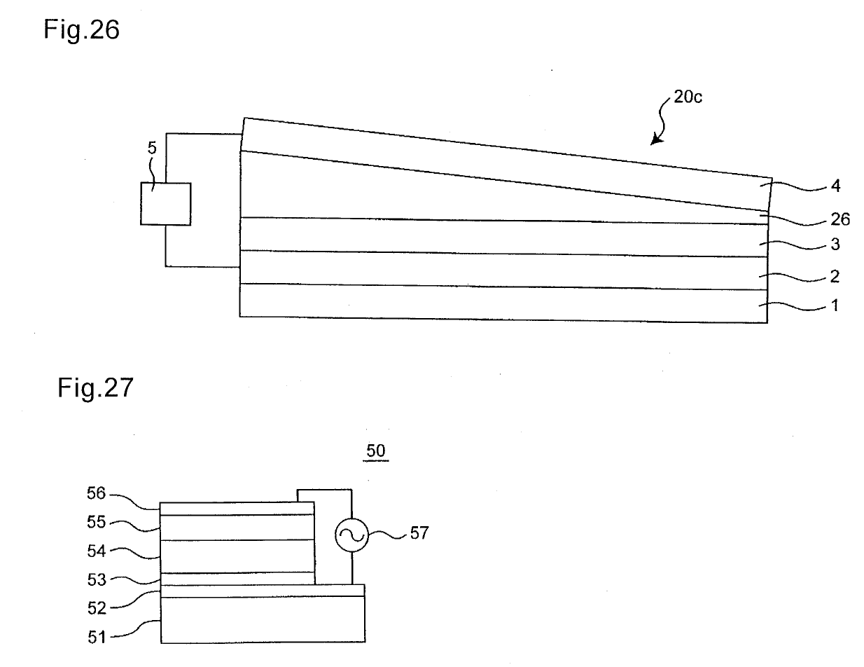

FIG. 26 is a cross-sectional view that schematically shows a linear light-emitting device 20c in accordance with eighth embodiment. This linear light-emitting device 20c in accordance with eighth embodiment of the present invention is characterized in that an electric resistance adjusting layer 26 is formed between the phosphor layer 3 and the metal electrode 4. This electric resistance adjusting layer 26 is designed so that its resistance value in the thickness direction is made smaller as the distance from the terminal formed on the transparent electrode 2 in the longitudinal direction is made longer. More specifically, the film thickness of the electric resistance adjusting layer 26 is continuously made smaller in such a manner as to be indicated by a linear function, as the distance from the terminal formed on the transparent electrode 2 in the longitudinal direction is made longer. By using the electric resistance adjusting layer 26, the current density of the phosphor layer 3 is made constant in the longitudinal direction so that the luminance can be made uniform in the longitudinal direction. In other words, by forming the electric resistance adjusting layer 26, the electric resistance values of the respective paths that extend from the terminals formed on the transparent electrode 2 to reach terminals attached to the metal electrode 4, through the transparent electrode 2, the phosphor layer 3 and the metal electrode 4, can be made virtually equal to one another, independent of the length from the terminal attached to the end portion of the transparent electrode 2 in the longitudinal direction. In the electric resistance adjusting layer 26, the specific resistance value of its material needs to be made higher than that of the metal electrode 4, and is preferably set closer to the specific resistance value of the phosphor layer material or the transparent electrode material.

In the linear light-emitting device 20c of the present eighth embodiment, the resistance value in the thickness direction is changed by continuously changing the film thickness of the electric resistance adjusting layer 26 in the longitudinal direction; however, the materials, the structures and the forming methods of the respective components, shown here, are examples, and the present invention is not particularly intended to be limited thereby.

The linear light-emitting device of the present invention is capable of providing a linear light source having high uniformity in luminance, in particular, as a linear light source with high uniformity in luminance. In particular, the linear light-emitting device can be applied to a linear light source used as a light source for use in a backlight of a liquid crystal display.

1. A linear light-emitting device comprising:
a pair of first and second linear electrodes opposing each other; and
a linear phosphor layer sandwiched between the paired electrodes,
wherein at least one of the paired first and second electrodes is a transparent electrode, and the phosphor layer has a polycrystalline structure made from a first semiconductor substance, with a second semiconductor substance different from the first semiconductor substance being segregated on a grain boundary of the polycrystalline structure.

2. The linear light-emitting device according to claim 1, wherein the phosphor layer has an electric resistance value between the first and second electrodes that is varied in a longitudinal direction.

3. The linear light-emitting device according to claim 1, wherein the phosphor layer is divided into a plurality of regions by a plurality of insulators placed between the paired electrodes.

4. The linear light-emitting device according to claim 1, wherein the phosphor layer has a film thickness that is varied in the longitudinal direction.

5. The linear light-emitting device according to claim 1, further comprising:
an electric resistance adjusting layer that is formed so as to be sandwiched between at least either one of the first and second electrodes and the phosphor layer, and has an electric resistance value that is varied in the longitudinal direction.

6. The linear light-emitting device according to claim 5, wherein the electric resistance adjusting layer has a film thickness that is varied in the longitudinal direction.

7. The linear light-emitting device according to claim 1, wherein the transparent electrode has a terminal to be connected to a power supply that is formed on one of end portions of two ends thereof in the longitudinal direction.

8. The linear light-emitting device according to claim 1, wherein the first semiconductor substance and the second semiconductor substance have semiconductor structures with mutually different conductive types.

9. The linear light-emitting device according to claim 1, wherein the first semiconductor substance has an n-type semiconductor structure and the second semiconductor substance has a p-type semiconductor structure.

10. The linear light-emitting device according to claim 1, wherein the first semiconductor substance and the second semiconductor substance are compound semiconductors respectively.

11. The linear light-emitting device according to claim 1, wherein the first semiconductor substance is a compound semiconductor consisting of Group 12 and Group 16.

12. The linear light-emitting device according to claim 1, wherein the first semiconductor substance has a cubic crystal structure.

13. The linear light-emitting device according to claim 1, wherein the first semiconductor substance comprises at least one kind of element selected from the group consisting of Cu, Ag, Au, Ir, Al, Ga, In, Mn, Cl, Br, I, Li, Ce, Pr, Nd, Pm, Sm, Eu, Gd, Tb, Dy, Ho, Er, Tm and Yb.

14. The linear light-emitting device according to claim 1, wherein the polycrystalline structure, made from the first semiconductor substance, has an average crystal grain size in a range from 5 to 500 nm.

15. The linear light-emitting device according to claim 1, wherein the second semiconductor substance comprises at least one kind of compound selected from the group consisting of Cu₂S, ZnS, ZnSe, ZnSSe, ZnSeTe, ZnTe, GaN and InGaN.

16. The linear light-emitting device according to claim 1, wherein the first semiconductor substance is a zinc-based material containing zinc, and at least one of the electrodes is made from a material containing zinc.

17. The linear light-emitting device according to claim 16, wherein the material containing zinc that forms one of the electrodes is mainly composed of zinc oxide, and contains at least one kind selected from the group consisting of aluminum, gallium, titanium, niobium, tantalum, tungsten, copper, silver and boron.

18. A linear light-emitting device comprising:
a pair of first and second linear electrodes opposing each other; and
a linear phosphor layer sandwiched between the paired electrodes,
wherein at least one of the paired first and second electrodes is a transparent electrode, and the phosphor layer has a p-type semiconductor and an n-type semiconductor.

19. The linear light-emitting device according to claim 18, wherein the phosphor layer has a structure in which n-type semiconductor particles are dispersed in a medium made from a p-type semiconductor.

20. The linear light-emitting device according to claim 18, wherein the phosphor layer is formed by an aggregated body of n-type semiconductor particles, with the p-type semiconductor being segregated between the particles.

21. The linear light-emitting device according to claim 19, wherein the n-type semiconductor particles are electrically jointed to the first and second electrodes through the p-type semiconductor.

22. The linear light-emitting device according to claim 18, wherein the phosphor layer has an electric resistance value between the first and second electrodes that is varied in a longitudinal direction.

23. The linear light-emitting device according to claim 18, wherein the phosphor layer is divided into a plurality of regions by a plurality of insulators placed between the paired electrodes.

24. The linear light-emitting device according to claim 18, wherein the phosphor layer has a film thickness that is varied in the longitudinal direction.

25. The linear light-emitting device according to claim 18, further comprising:
an electric resistance adjusting layer that is formed so as to be sandwiched between at least either one of the first and second electrodes and the phosphor layer, and has an electric resistance value that is varied in the longitudinal direction.

26. The linear light-emitting device according to claim 25, wherein the electric resistance adjusting layer has a film thickness that is varied in the longitudinal direction.

27. The linear light-emitting device according to claim 18, wherein the transparent electrode has a terminal to be connected to a power supply that is formed on one of end portions of two ends thereof in the longitudinal direction.

28. The linear light-emitting device according to claim 18, wherein the n-type semiconductor and the p-type semiconductor are compound semiconductors respectively.

29. The linear light-emitting device according to claim 18, wherein the n-type semiconductor is a compound semiconductor consisting of Group 12 and Group 16.

30. The linear light-emitting device according to claim 18, wherein the n-type semiconductor is a compound semiconductor consisting of Group 13 and Group 15.

31. The linear light-emitting device according to claim 18, wherein the n-type semiconductor is a chalcopyrite type compound semiconductor.

32. The linear light-emitting device according to claim 18, wherein the n-type semiconductor is at least one kind of compound selected from the group consisting of ZnS, ZnSe, ZnSSe, ZnSeTe, ZnTe, GaN and InGaN.

33. The linear light-emitting device according to claim 18, wherein the n-type semiconductor is a zinc-based material containing zinc, and at least either one of the first and second electrodes is made from a material containing zinc.

34. The linear light-emitting device according to claim 33, wherein the material containing zinc that forms one of the electrodes is mainly composed of zinc oxide, and contains at least one kind selected from the group consisting of aluminum, gallium, titanium, niobium, tantalum, tungsten, copper, silver and boron.

35. The linear light-emitting device according to claim 18, further comprising:
a supporting substrate that faces at least one of the electrodes and supports the device.

36. The linear light-emitting device according to claim 1, further comprising:
a color conversion layer that faces the respective electrodes, and is placed in front of the direction in which light is emitted.

37. A plane light source comprising:
a linear light-emitting device disclosed in claim 1; and
a light-directing plate that reflects linear light outputted from the linear light-emitting device to form planar light.
